(19) United States
(12) Patent Application Publication
(10) Pub. No.: US 2026/0071406 A1
(43) Pub. Date: Mar. 12, 2026

(54) DYNAMIC WORKFLOW ADJUSTMENT TO ASSIST HEAVY MACHINES INVOLVED IN ACCIDENTAL SCENARIOS

(71) Applicant: International Business Machines Corporation, Armonk, NY (US)

(72) Inventors: Martin G. Keen, Cary, NC (US); Jennifer M. Hatfield, Portland, OR (US); Sarbajit Kumar Rakshit, Kolkata (IN); Carolina Garcia Delgado, Zapopan (MX)

(21) Appl. No.: 18/829,091

(22) Filed: Sep. 9, 2024

(51) Int. Cl. E02F 9/20; E02F 9/26; G06N 5/04

(52) U.S. Cl. CPC E02F 9/2054; E02F 9/205; E02F 9/267; G06N 5/04

(57) ABSTRACT

Described are techniques for dynamic workflow adjustments to assist heavy machines involved in accidental scenarios. Real-time data associated with an activity area where a heavy machine is performing an activity is monitored. The monitored data may then be analyzed by a first trained artificial intelligence (AI) model to determine if an accidental scenario is detected or predicted. Upon detecting or predicting an accidental scenario, a knowledge repository including information, such as the capabilities of heavy machines, is analyzed. Based on the analysis of the knowledge repository, a second AI model identifies a heavy machine to mitigate the accidental scenario. Furthermore, the second AI model adjusts the workflow for the heavy machine providing the assistance and/or for the heavy machine engaged in the activity involving the detected or predicted accidental scenario. The identified heavy machine may then be deployed to perform the adjusted workflow to mitigate the accidental scenario.

### TECHNICAL FIELD

The present disclosure relates generally to heavy machinery.

### BACKGROUND

Heavy machinery (also referred to as “heavy equipment,” “earthmovers,” “construction vehicles,” or “construction equipment”) refers to heavy-duty vehicles specially designed to execute construction tasks, most frequently involving earthwork operations or other large construction tasks. Heavy machinery usually includes five equipment systems: the implement, traction, structure, power train, and control/information. Examples of heavy machinery include backhoes, back end and front-end loaders, bulldozers, casting machines, cherry pickers, combines and other farming equipment, cranes, compactors, drilling, punching, and shearing equipment, dump trucks, excavators, forklifts, hydraulic presses, lathes, mixers, pay haulers and pay loaders, pipe and tube benders, road graders and rollers, scrapers, and trenchers.

### SUMMARY

In one embodiment of the present disclosure, a computer-implemented method for dynamic workflow adjustments to assist heavy machines involved in accidental scenarios comprises monitoring real-time data associated with a first activity area where a first heavy machine is performing an activity. The method further comprises analyzing the real-time data. The method additionally comprises inferring an accidental scenario involving the first heavy machine by a first trained artificial intelligence model based on the analysis of the real-time data. Furthermore, the method comprises analyzing a knowledge repository pertaining to capabilities of the first heavy machine and one or more other heavy machines. Additionally, the method comprises identifying a second heavy machine of the one or more other heavy machines to assist the first heavy machine to mitigate the inferred accidental scenario by a second trained artificial intelligence model based on the analysis of the knowledge repository. In addition, the method comprises deploying the second heavy machine to assist the first heavy machine to mitigate the inferred accidental scenario.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates the internal components of a heavy machine in accordance with an embodiment of the present disclosure;

FIG. 3 is a diagram of the software components used by the workflow adjuster for dynamically adjusting workflows to assist the heavy machines involved in accidental scenarios ensuring that any detected or predicted accidental scenario is effectively addressed while maintaining operational efficiency in accordance with an embodiment of the present disclosure;

FIG. 4 illustrates activity areas involving heavy machines performing various activities in accordance with an embodiment of the present disclosure;

FIG. 5 illustrates pausing activities being performed by the assisting heavy machines in their activity area so that they can be used to perform tasks in the activity area involving the detected or predicted accidental scenario in accordance with an embodiment of the present disclosure;

FIG. 6 illustrates deploying the heavy machines to perform their adjusted workflows to mitigate the detected or predicted accidental scenario in accordance with an embodiment of the present disclosure;

FIG. 7 illustrates a workflow map illustrating the heavy machines being assigned to mitigate the detected or predicted accidental scenario in accordance with an embodiment of the present disclosure;

FIG. 8 illustrates an embodiment of the present disclosure of the hardware configuration of the workflow adjuster which is representative of a hardware environment for practicing the present disclosure;

FIG. 9 is a flowchart of a method for building and training an artificial intelligence model for detecting or predicting an accidental scenario in accordance with an embodiment of the present disclosure;

FIG. 10 is a flowchart of a method for building and training an artificial intelligence model for identifying a heavy machine(s) to assist the heavy machine engaged in the activity involving a detected or predicted accidental scenario as well as to dynamically adjust a workflow(s) for the assisting heavy machine(s) and/or the heavy machine engaged in the activity involving the detected or predicted accidental scenario so as to mitigate the detected or predicted accidental scenario in accordance with an embodiment of the present disclosure; and

FIGS. 11A-11B are a flowchart of a method for dynamically adjusting the workflow to assist the heavy machines involved in the accidental scenario in accordance with an embodiment of the present disclosure.

### DETAILED DESCRIPTION

As stated above, heavy machinery (also referred to as “heavy equipment,” “earthmovers,” “construction vehicles,” or “construction equipment”) refers to heavy-duty vehicles specially designed to execute construction tasks, most frequently involving earthwork operations or other large construction tasks. Heavy machinery usually includes five equipment systems: the implement, traction, structure, power train, and control/information. Examples of heavy machinery include backhoes, back end and front-end loaders, bulldozers, casting machines, cherry pickers, combines and other farming equipment, cranes, compactors, drilling, punching, and shearing equipment, dump trucks, excavators, forklifts, hydraulic presses, lathes, mixers, pay haulers and pay loaders, pipe and tube benders, road graders and rollers, scrapers, and trenchers.

Accidents within heavy machinery industries encompass a range of hazardous scenarios that can lead to significant consequences for both personnel and equipment. These industries involve complex machinery, intricate processes, and the manipulation of heavy loads, making the potential for accidents a serious concern. Mishaps can arise from various factors, including structural imbalances during material lifting, equipment malfunctions, operator errors, crushing hazards, falling objects, fires, chemical exposure, electrical mishaps, overloading, collisions, inadequate maintenance, and adverse weather conditions. Such accidents can result in injuries, fatalities, property damage, production disruptions, and financial losses. Effective safety protocols, training, regular maintenance, and adherence to proper operational procedures are essential to mitigate these risks and create a safer environment within heavy machinery industries. In heavy machinery industries, various accidental scenarios (situations that may be the cause of an accident occurring) can occur, such as structural imbalance during lifting. For example, while lifting heavy materials, a structural imbalance can cause machinery to tilt, leading to potential instability, material dropping, and machinery damage.

Another example of an accidental scenario is equipment malfunction. Mechanical failures or technical glitches in heavy machinery can result in sudden stops, unexpected movements, or loss of control, posing risks to operators and bystanders.

A further example of an accidental scenario is operator error. Mistakes in operating complex machinery, misjudgments, or incorrect procedures can lead to accidents, collisions, or improper material handling.

Another example of an accidental scenario is crushing hazards. Workers can get caught between moving parts or between machinery and stationary structures, causing severe injuries or fatalities.

Falling objects is another example of an accidental scenario. Loose materials, tools, or equipment falling from heights can strike workers causing injuries.

Another example of an accidental scenario involves fire or explosions. Equipment malfunctions, electrical issues, or fuel leaks can trigger fires or explosions in machinery, endangering workers and property.

A further example of an accidental scenario involves chemical exposure. In industries using chemicals, accidental spills or leaks can expose workers to hazardous substances, leading to health risks.

Another example of an accidental scenario involves electrical hazards. Faulty wiring or improper use of electrical equipment can result in electrical shocks, fires, or electrocution.

A further example of an accidental scenario involves overloading. Exceeding the machinery's capacity limits can lead to structural failures, component damage, or tipping over.

Another example of an accidental scenario involves collisions. Accidental collisions between heavy machinery, vehicles, or structures can result in damage, injuries, or even fatalities.

Inadequate maintenance is another example of a cause of an accidental scenario. For example, neglecting regular maintenance can lead to machinery breakdowns, reduced performance, and safety hazards.

Furthermore, weather conditions may be a cause of an accidental scenario. Adverse weather, such as rain, snow, wind, or ice can impact visibility, traction, and machinery stability, increasing accident risks.

In heavy machinery operations, unexpected scenarios or accidents can jeopardize the safety of the operation and the efficiency of the workflow. A workflow refers to the series of steps that a heavy machine performs in order to achieve a task or goal over time.

Currently, mechanisms or systems for addressing such accidental scenarios are deficient. For example, context sensing technology may be employed to detect when an operator is texting while operating the heavy machinery. However, such technology is limited to only addressing potential operator errors.

Unfortunately, there are currently no mechanisms or systems for effectively addressing the wide range of accidental scenarios, which require immediate detection and dynamic allocation of available resources to support and mitigate the accidental scenarios.

The embodiments of the present disclosure provide a means for dynamically adapting workflows among heavy machines ensuring that any detected or predicted accidental scenario is effectively addressed while maintaining operational efficiency. In one embodiment, a first artificial intelligence model is built and trained to detect or predict an accidental scenario. An accidental scenario, as used herein, refers to situations that may be the cause of an accident occurring. For example, structural imbalance during lifting, equipment malfunction, operator error, crushing hazards, falling objects, fire or explosions, chemical exposure, electrical hazards, overloading, collisions, inadequate maintenance, and adverse weather conditions are examples of accidental scenarios involving situations that may lead to accidents within the heavy machine industry. Furthermore, in one embodiment, a second artificial intelligence model is built and trained to identify heavy machine(s) to assist a heavy machine engaged in an activity involving a detected or predicted accidental scenario. Upon detecting or predicting an accidental scenario involving a heavy machine performing an activity in an activity area, the second artificial intelligence model identifies one or more alternative heavy machines to assist the heavy machine in mitigating the detected or predicted accidental scenario. For example, if the heavy machine's capacity limits exceeded a threshold limit, then an accidental scenario is detected or predicted since a structural failure is likely to occur. An alternative heavy machine may then be identified to assist the heavy machine (heavy machine engaged in an activity involving the detected or predicted accidental scenario) in mitigating the detected or predicted accidental scenario, such as by performing the task that was previously assigned to the heavy machine (heavy machine engaged in the activity involving the detected or predicted accidental scenario) with the exceeded capacity limits since the alternative heavy machine is designed with a greater capacity limit. In one embodiment, workflows involving the heavy machine (heavy machine engaged in an activity involving the detected or predicted accidental scenario) and/or the alternative heavy machine are adjusted. For example, the workflow of the heavy machine engaged in the activity involving the detected or predicted accidental scenario may be adjusted to accommodate support actions from the alternative heavy machine. In another example, the workflow for the alternative heavy machine may be adjusted to temporarily pause activity being performed in its activity area and to include tasks to be performed at the activity area of the heavy machine to be assisted (heavy machine engaged in the activity involving the detected or predicted accidental scenario). The alternative heavy machine may then be deployed to perform the adjusted workflow. In this manner, workflows may be dynamically adjusted to assist heavy machines involved in accidental scenarios ensuring that any detected or predicted accidental scenario is effectively addressed while maintaining operational efficiency. These and other features will be discussed in further detail below.

In some embodiments of the present disclosure, the present disclosure comprises a computer-implemented method, system, and computer program product for dynamic workflow adjustments to assist heavy machines involved in accidental scenarios. In one embodiment of the present disclosure, real-time data associated with an activity area where a heavy machine is performing an activity, such as drilling, lifting, loading, pressing, etc., is monitored. Examples of such real-time data include vibration levels, emission levels, internal temperatures of heavy machines, structural shifts, outdoor temperature, humidity, current weather conditions, images of an activity area's environment, temporal or spatial events from captured images or videos, etc. The monitored data may then be analyzed by a first trained artificial intelligence model (trained to detect or predict an accidental scenario) to determine if an accidental scenario is detected or predicted. Upon detecting or predicting an accidental scenario by the first trained artificial intelligence model, a knowledge repository including information, such as the capabilities of the heavy machine engaged in an activity involving the detected or predicted accidental scenario as well as other heavy machines, is analyzed. Other information stored in the knowledge repository include the proximity of the heavy machines to the heavy machine engaged in the activity involving a detected or predicted accidental scenario, the availability of the other heavy machines to assist the heavy machine engaged in the activity involving a detected or predicted accidental scenario, the operational status of the other heavy machines, the priority of the detected or predicted accidental scenario, etc. Based on the analysis of the knowledge repository, a second artificial intelligence model (trained to identify a heavy machine(s) to assist the heavy machine engaged in the activity involving a detected or predicted accidental scenario as well as to dynamically adjust a workflow(s) to mitigate the detected or predicted accidental scenario) identifies a heavy machine to assist the heavy machine (heavy machine engaged in the activity involving a detected or predicted accidental scenario) to mitigate the detected or predicted accidental scenario. Furthermore, the second artificial intelligence model adjusts the workflow for the heavy machine providing the assistance and/or for the heavy machine engaged in the activity involving the detected or predicted accidental scenario. For example, the workflow for the heavy machine providing the assistance may be adjusted to include the tasks, tools, expertise, and procedures for addressing the accidental scenario in order to mitigate the accidental scenario. In a further example, the workflow for the heavy machine engaged in the activity involving the detected or predicted accidental scenario may be adjusted to accommodate the support actions from the heavy machine providing the assistance. In another example, the workflow for the heavy machine providing the assistance may be adjusted to temporarily pause activity of the heavy machine being performed in its activity area and to include tasks to be performed in the activity area involving the detected or predicted accidental scenario. The identified heavy machine may then be deployed to perform the adjusted workflow to mitigate the detected or predicted accidental scenario. In this manner, workflows may be dynamically adjusted to assist heavy machines involved in accidental scenarios ensuring that any detected or predicted accidental scenario is effectively addressed while maintaining operational efficiency.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

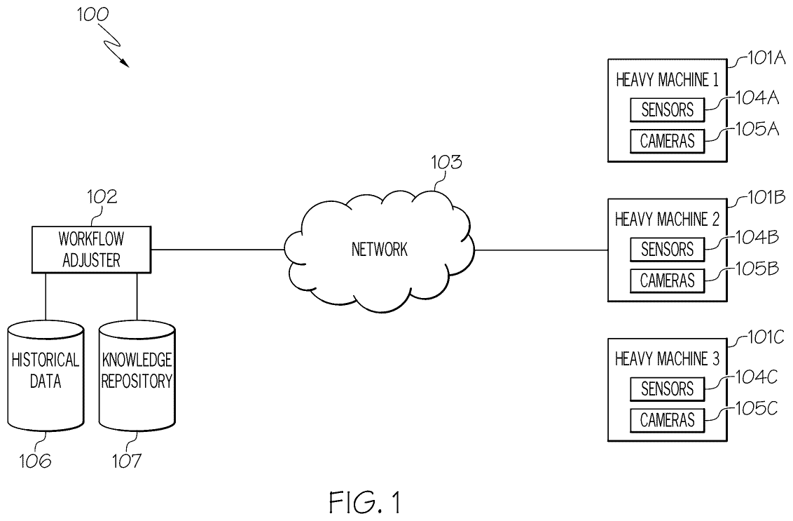

Referring now to the Figures in detail, FIG. 1 illustrates an embodiment of the present disclosure of a communication system 100 for practicing the principles of the present disclosure. Communication system 100 includes heavy machines 101A-101C (identified as “heavy machine 1,” “heavy machine 2,” and “heavy machine 3,” respectively in FIG. 1) connected to a workflow adjuster 102 via a network 103.

Heavy machines 101A-101C may collectively or individually be referred to as heavy machines 101 or heavy machine 101, respectively. While FIG. 1 illustrates system 100 including three heavy machines 101, system 100 may include any number of heavy machines 101.

A heavy machine 101, as used herein, refers to heavy-duty vehicles specially designed to execute construction tasks, most frequently involving earthwork operations or other large construction tasks. Examples of heavy machines 101 include backhoes, back end and front-end loaders, bulldozers, casting machines, cherry pickers, combines and other farming equipment, cranes, compactors, drilling, punching, and shearing equipment, dump trucks, excavators, forklifts, hydraulic presses, lathes, mixers, pay haulers and pay loaders, pipe and tube benders, road graders and rollers, scrapers, and trenchers.

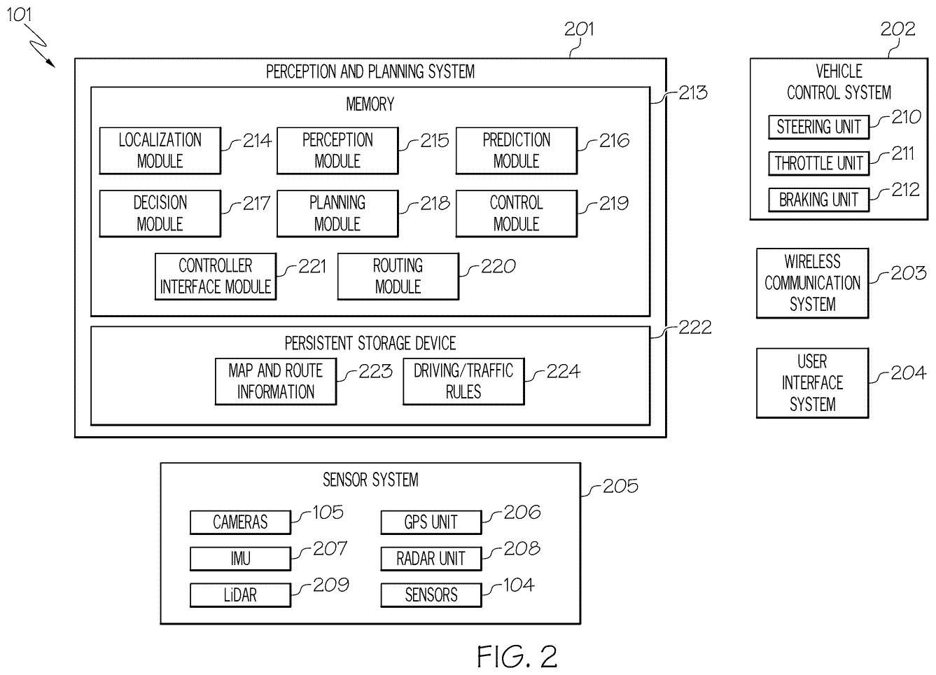

In one embodiment, heavy machine 101 is autonomous. An autonomous heavy machine, as used herein, refers to a heavy machine capable of sensing its environment and operating without human involvement. A description of the internal components of such an embodiment of heavy machine 101 is provided below in connection with FIG. 2. In one embodiment, heavy machine 101 is controlled by a human operator.

In one embodiment, heavy machines 101, such as heavy machines 101A-101C, include sensors 104A-104C, respectively. Sensors 104A-104C may collectively or individually be referred to as sensors 104 or sensor 104, respectively.

In one embodiment, sensors 104 may correspond to Internet of Things (IoT) sensors. An IoT sensor, as used herein, refers to a sensor that can be attached to or embedded within heavy machine 101. Furthermore, IoT sensors are configured to exchange data with other devices and systems over a network, such as network 103. In one embodiment, IoT sensors are configured to monitor materials lifted by heavy machine 101, such as the weight of such materials, monitor equipment movements to detect equipment malfunctions, monitor operator movements to detect operator errors, monitor for falling objects, monitor for electrical issues or fuel leaks which can trigger a fire or explosion, monitor for chemical leaks or spills which can expose workers to hazardous substances, monitor for faulty electrical wiring which can lead to electrical hazards, monitor for exceeding capacity limits of heavy machine 101 leading to possible structural failure, component damage, etc., monitor for collisions, monitor for inadequate maintenance, monitor for adverse weather conditions, etc.

Furthermore, in one embodiment, an IoT sensor, which may be attached to heavy machine 101, corresponds to a geolocation IoT sensor, which may be used by workflow adjuster 102 to identify the location of heavy machine 101 in real-time via the use of an IoT-based global position system (GPS) tracking system.

Furthermore, in one embodiment, sensors 104 may include temperature sensors and vibration sensors which are used to detect temperature and vibration data that can be used to detect the onset of mechanical failure.

Additionally, in one embodiment, sensors 104 may include accelerometers for measuring acceleration, gyroscopes for measuring orientation and angular velocity, inclinometers for measuring the angle of inclination, ground movement sensors for measuring vibrations and other activities on the ground, etc. that can be used to monitor vibrations, ground movement, and structural changes.

A further discussion regarding sensors 104 is provided below in connection with FIG. 2.

Furthermore, in one embodiment, heavy machines 101, such as heavy machines 101A-101C, include cameras 105A-105C, respectively. Cameras 105A-105C may collectively or individually be referred to as cameras 105 or camera 105, respectively. Camera 105 may include one or more devices to capture images of the environment surrounding heavy machine 101. Camera 105 may be still cameras and/or video cameras. Camera 105 may be mechanically movable, for example, by mounting camera 105 on a rotating and/or tilting a platform.

A further discussion regarding cameras 105 is provided below in connection with FIG. 2.

In one embodiment, such sensors 104 and cameras 105 are installed at strategic locations of the activity area. An activity area, as used herein, refers to a particular part of a place or land where heavy machine 101 is performing an activity, such as drilling, lifting, loading, pressing, etc.

In one embodiment, workflow adjuster 102 is configured to dynamically adapt workflows among heavy machines 101 ensuring that any detected or predicted accidental scenario is effectively addressed while maintaining operational efficiency. An accidental scenario, as used herein, refers to situations that may be the cause of an accident occurring. For example, structural imbalance during lifting, equipment malfunctions, operator errors, crushing hazards, falling objects, fire or explosions, chemical exposure, electrical hazards, overloading, collisions, inadequate maintenance, and adverse weather conditions are examples of accidental scenarios involving situations that may lead to accidents within the heavy machine industry.

In one embodiment, such accidental scenarios are detected or predicted based on monitoring and analyzing real-time data acquired by sensors 104 and cameras 105 involving an activity area where heavy machine 101 is performing an activity.

In one embodiment, workflow adjuster 102 builds and trains a first artificial intelligence model to detect or predict an accidental scenario. Such a trained artificial intelligence model may be utilized to analyze the real-time data acquired by sensors 104 and cameras 105 to determine if an accidental scenario involving an activity area where heavy machine 101 is performing an activity has been detected or predicted.

Furthermore, in one embodiment, workflow adjuster 102 builds and trains a second artificial intelligence model to identify heavy machine(s) 101 (e.g., heavy machines 101B, 101C) to assist heavy machine 101 (e.g., heavy machine 101A) engaged in an activity involving a detected or predicted accidental scenario. Upon detecting or predicting an accidental scenario involving heavy machine 101 (e.g., heavy machine 101A) performing an activity in an activity area, the artificial intelligence model identifies one or more alternative heavy machines 101 (e.g., heavy machines 101B, 101C) to assist heavy machine 101 (e.g., heavy machine 101A) in mitigating the detected or predicted accidental scenario. For example, if the heavy machine's capacity limits exceeded a threshold limit, then a structural failure may occur thereby resulting in an accidental scenario being detected or predicted. An alternative heavy machine 101 (e.g., heavy machine 101B) may then be identified to assist heavy machine 101 (e.g., heavy machine 101A) in mitigating the detected or predicted accidental scenario, such as by performing the task that was previously assigned to heavy machine 101 (e.g., heavy machine 101A) with the exceeded capacity limits since the alternative heavy machine 101 (e.g., heavy machine 101B) is designed with a greater capacity limit.

In one embodiment, the second artificial intelligence model is trained to identify heavy machine(s) 101 (e.g., heavy machines 101B, 101C) to assist heavy machine 101 (e.g., heavy machine 101A) engaged in an activity involving a detected or predicted accidental scenario based on historical data, which may be stored in a database 106 connected to workflow adjuster 102. In one embodiment, such historical data pertains to heavy machines 101 assisting heavy machines 101 engaged in activities involving a detected or predicted accidental scenario. Examples of such historical data include the capabilities of the heavy machines, the proximity of the assisting heavy machines that were selected to assist the heavy machine in need of assistance, the availability of the assisting heavy machines to assist the heavy machine in need of assistance, the operational status of the assisting heavy machines that were used to assist the heavy machine in need of assistance, capability scores (score that indicates the degree that a heavy machine has the capability to assist the heavy machine in need of assistance, including finishing the task(s) assigned to the heavy machine in need of assistance), accidental scenario priorities (accidental scenarios may be prioritized based on their potential impact on safety, operations, and equipment) , etc.

Furthermore, in one embodiment, the trained second artificial intelligence model identifies heavy machine(s) 101 (e.g., heavy machines 101B, 101C) to assist heavy machine 101 (e.g., heavy machine 101A) engaged in an activity involving a detected or predicted accidental scenario based on analyzing a knowledge repository 107 connected to workflow adjuster 102. Knowledge repository 107, as used herein, refers to a collection of knowledge-based information, which may reside in a database. In one embodiment, knowledge repository 107 includes knowledge-based information pertaining to the capabilities of heavy machines 101, including the currently active heavy machines 101 that are operating in or near the activity area where an accidental scenario was detected or predicted. In one embodiment, such knowledge-based information in knowledge repository 107 includes information pertaining to the proximity of heavy machines 101 to heavy machine 101 that needs assistance, where the proximity is determined based on the current locations of heavy machines 101. In one embodiment, such knowledge-based information in knowledge repository 107 includes the availability of heavy machines 101 assisting heavy machine 101 in need of assistance. In one embodiment, such knowledge-based information in knowledge repository 107 includes the operational status of heavy machines 101. In one embodiment, such knowledge-based information includes the priority of the detected or predicted accidental scenario, which may be prioritized based on their potential impact on safety, operations, and equipment. In one embodiment, knowledge repository 107 is populated by an expert.

In one embodiment, workflow adjuster 102 adjusts the workflow of heavy machine 101 that needs assistance (heavy machine 101 engaged in an activity involving the detected or predicted accidental scenario) to accommodate support actions from the alternative heavy machine 101. In one embodiment, workflow adjuster 102 adjusts the workflow of heavy machine 101 that is providing assistance, such as temporarily pausing activity being performed in its activity area and to include tasks to be performed at the activity area of heavy machine 101 (heavy machine 101 that is engaged in an activity involving the detected or predicted accidental scenario).

In one embodiment, workflow adjuster 102 deploys heavy machine(s) 101 to provide assistance to heavy machine 101 in need of assistance. In one embodiment, such deployment involves performing the adjusted workflow.

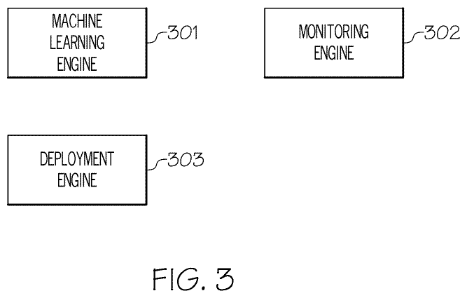

A description of the software components of workflow adjuster 102 used for dynamically adjusting workflows to assist heavy machines 101 involved in accidental scenarios ensuring that any detected or predicted accidental scenario is effectively addressed while maintaining operational efficiency is provided below in connection with FIG. 3. A description of the hardware configuration of workflow adjuster 102 is provided further below in connection with FIG. 8.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of heavy machines 101, workflow adjusters 102, networks 103, sensors 104, cameras, 105, databases 106, and knowledge repositories 107.

Referring now to FIG. 2, FIG. 2 illustrates the internal components of heavy machine 101, such as an autonomous heavy machine, in accordance with an embodiment of the present disclosure.

As shown in FIG. 2, in conjunction with FIG. 1, heavy machine 101 includes, but is not limited to, perception and planning system 201, vehicle control system 202, wireless communication system 203, user interface system 204, and sensor system 205. Heavy machine 101 may further include certain common components included in ordinary vehicles, such as, an engine, wheels, steering wheel, transmission, etc., which may be controlled by vehicle control system 202 and/or perception and planning system 201 using a variety of communication signals and/or commands, such as, for example, acceleration signals or commands, deceleration signals or commands, steering signals or commands, braking signals or commands, etc.

Components 201-205 may be communicatively coupled to each other via an interconnect, a bus, a network, or a combination thereof. For example, components 201-205 may be communicatively coupled to each other via a controller area network (CAN) bus. A CAN bus is a vehicle bus standard designed to allow microcontrollers and devices to communicate with each other in applications without a host computer.

In one embodiment, sensor system 205 includes, but it is not limited to, one or more sensors 104, such as IoT sensors, one or more cameras 105, global positioning system (GPS) unit 206, inertial measurement unit (IMU) 207, radar unit 208, and a light detection and range (LiDAR) unit 209. GPS unit 206 may include a transceiver operable to provide information regarding the position of heavy machine 101. IMU 207 may sense position and orientation changes of heavy machine 101 based on inertial acceleration. Radar unit 208 may represent a system that utilizes radio signals to sense objects within the local environment of heavy machine 101. In one embodiment, in addition to sensing objects, radar unit 208 may additionally sense the speed and/or heading of the objects. LiDAR unit 209 may sense objects in the environment in which heavy machine 101 is located using lasers. LiDAR unit 209 could include one or more laser sources, a laser scanner, and one or more detectors, among other system components. Cameras 105 may include one or more devices to capture images of the environment surrounding heavy machine 101. Cameras 105 may be still cameras and/or video cameras. A camera may be mechanically movable, for example, by mounting the camera on a rotating and/or tilting a platform.

Sensor system 205 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 202 includes, but are not limited to, steering unit 210, throttle unit 211 (also referred to as an acceleration unit), and braking unit 212. Steering unit 210 is to adjust the direction or heading of the vehicle. Throttle unit 211 is to control the speed of the motor or engine that in turn controls the speed and acceleration of the vehicle. Braking unit 212 is to decelerate the vehicle by providing friction to slow the wheels or tires of the vehicle.

Furthermore, in one embodiment, wireless communication system 203 is to allow communication between heavy machine 101 and external systems, such as workflow adjuster 102. For example, wireless communication system 203 can wirelessly communicate with one or more devices directly or via a communication network, such as workflow adjuster 102 over network 103. Wireless communication system 203 can use any cellular communication network or a wireless local area network (WLAN) (e.g., using WiFi to communicate with another component or system). In one embodiment, wireless communication system 203 communicates directly with a device (e.g., a speaker within heavy machine 101), for example, using an infrared link, Bluetooth, etc.

In one embodiment, user interface system 204 is part of the peripheral devices implemented within heavy machine 101 including, for example, a keyboard, a touch screen display device, a microphone, a speaker, etc.

Some or all of the functions of heavy machine 101 may be controlled or managed by perception and planning system 201, especially when operating in an autonomous driving mode. Perception and planning system 201 includes the necessary hardware (e.g., processor(s), memory, storage) and software (e.g., operating system, planning and routing programs) to receive information from sensor system 205, vehicle control system 202, wireless communication system 203, and/or user interface system 204, process the received information, plan a route or path from a starting point to a destination point, and then drive heavy machine 101 based on the planning and control information. Alternatively, perception and planning system 201 may be integrated with vehicle control system 202.

For example, workflow adjuster 102 specifies a starting location and a destination of a trip, for example, via a user interface. Perception and planning system 201 obtains the trip related data. For example, perception and planning system 201 may obtain location and route information from workflow adjuster 102. For instance, workflow adjuster 102 provides location and map services. Alternatively, such location and map services information may be cached locally in a persistent storage device of perception and planning system 201.

While heavy machine 101 is moving along the route, perception and planning system 201 may also obtain real-time traffic information from workflow adjuster 102, which obtained such information from a traffic information system or server (TIS). Based on the real-time traffic information, location information, as well as real-time local environment data detected or sensed by sensor system 205 (e.g., obstacles, objects, nearby vehicles), workflow adjuster 102 and/or perception and planning system 201 can plan an optimal route, where perception and planning system 201 drives heavy machine 101, for example, via vehicle control system 202, according to the planned route to reach the specified destination safely and efficiently.

In one embodiment, perception and planning system 201 includes a memory 213 for storing a localization module 214, perception module 215, prediction module 216, decision module 217, planning module 218, control module 219, routing module 220, and controller interface module 221.

In one embodiment, such modules (modules 214-221) are installed in persistent storage device 222, loaded into memory 213, and executed by one or more processors (not shown). It is noted that some or all of these modules may be communicatively coupled to or integrated with some or all modules of vehicle control system 202 of FIG. 2. Some of modules 214-221 may be integrated together as an integrated module.

In one embodiment, localization module 214 determines a current location of heavy machine 101 (e.g., leveraging GPS unit 206) and manages any data related to a trip or route of heavy machine 101. Localization module 214 (also referred to as a map and route module) manages any data related to a trip or route of heavy machine 101. Localization module 214 communicates with other components of heavy machine 101, such as map and route information 223, to obtain the trip related data. For example, localization module 214 may obtain location and route information from workflow adjuster 102. Workflow adjuster 102 provides location and map services, which may be cached as part of map and route information 223. While heavy machine 101 is moving along the route, localization module 214 may also obtain real-time traffic information from workflow adjuster 102 and/or a traffic information system or server.

Based on the sensor data provided by sensor system 205 and localization information obtained by localization module 214, a perception of the surrounding environment is determined by perception module 215. The perception information may represent what an ordinary driver would perceive surrounding a vehicle in which the driver is driving. The perception can include a relative position of another vehicle, a building, mounds of dirt, etc., for example, in a form of an object.

Perception module 215 may include a computer vision system or functionalities of a computer vision system to process and analyze images captured by one or more cameras in order to identify objects and/or features in the environment of heavy machine 101. The objects can include other vehicles, obstacles, etc. The computer vision system may use an object recognition algorithm, video tracking, and other computer vision techniques. In some embodiments, the computer vision system can map an environment, track objects, and estimate the speed of objects, etc. Perception module 215 can also detect objects based on other data provided by other sensors, such as a radar and/or LiDAR.

For each of the objects, prediction module 216 predicts what the object will behave under the circumstances. The prediction is performed based on perception module 215 perceiving the driving environment at the point in time in view of a set of map and route information 223 and driving/traffic rules 224. For example, if the object is a vehicle at an opposing direction and the current driving environment includes a hole previously dug out, prediction module 216 will predict whether the vehicle will likely move straight forward or make a turn.

For each of the objects, decision module 217 makes a decision regarding how to handle the object. For example, for a particular object (e.g., another vehicle in a crossing route) as well as its metadata describing the object (e.g., a speed, direction, turning angle), decision module 217 decides how to encounter the object (e.g., overtake, yield, stop, pass). Decision module 217 may make such decisions according to a set of rules, such as traffic rules or driving rules 224, which may be stored in persistent storage device 222.

In one embodiment, workflow adjuster 102 and/or routing module 220 are configured to provide one or more routes or paths from a starting point to a destination point. In one embodiment, for a given trip from a start location to a destination location, for example, received from workflow adjuster 102, routing module 220 obtains map and route information 223 and determines all possible routes or paths from the starting location to reach the destination location. Routing module 220 may generate a reference line in a form of a topographic map for each of the routes it determines from the starting location to reach the destination location. A reference line refers to an ideal route or path without any interference from others, such as other vehicles, obstacles, etc. That is, if there is no other vehicle, pedestrians, or obstacles on the road, an autonomous vehicle should exactly or closely follow the reference line. The topographic maps are then provided to decision module 217 and/or planning module 218. Decision module 217 and/or planning module 218 examine all of the possible routes to select and modify one of the most optimal routes in view of other data provided by other modules, such as traffic conditions from localization module 214, driving environment perceived by perception module 215, and traffic conditions predicted by prediction module 216. The actual path or route for heavy machine 101 may be close to or different from the reference line provided by workflow adjuster 102 and/or routing module 220 dependent upon the specific driving environment at the point in time.

Based on a decision for each of the objects perceived, planning module 218 plans a path or route for heavy machine 101 as well as driving parameters (e.g., distance, speed, and/or turning angle) using a reference line provided by routing module 220 as a basis. Alternatively, such a path or route for heavy machine 101 as well as driving parameters (e.g., distance, speed, and/or turning angle) are received from workflow adjuster 102.

In one embodiment, for a given object, decision module 217 decides what to do with the object, while planning module 218 determines how to do it. For example, for a given object, decision module 217 may decide to pass the object, while planning module 218 may determine whether to pass on the left side or right side of the object. Planning and control data is generated by planning module 218 including information describing how heavy machine 101 would move in a next moving cycle (e.g., next route/path segment). For example, the planning and control data may instruct heavy machine 101 to move to the left 10 meters at a speed of 5 miles per hour (mph), then move to the right 15 meters at the speed of 8 mph.

Based on the planning and control data, control module 219 controls and drives heavy machine 101, by sending proper commands or signals to vehicle control system 202, according to a route or path defined by the planning and control data. The planning and control data includes sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 218 plans a next route segment or path segment, for example, including a target position and the time required for heavy machine 101 to reach the target position. Alternatively, planning module 218 may further specify the specific speed, direction, and/or steering angle, etc. In one embodiment, planning module 218 plans a route segment or path segment for the next predetermined period of time, such as 5 seconds. For each planning cycle, planning module 218 plans a target position for the current cycle (e.g., next 5 seconds) based on a target position planned in a previous cycle. Control module 219 then generates one or more control commands (e.g., throttle, brake, steering control commands) based on the planning and control data of the current cycle.

It is noted that decision module 217 and planning module 218 may be integrated as an integrated module. Decision module 217/planning module 218 may include a navigation system or functionalities of a navigation system to determine a driving path for heavy machine 101. For example, the navigation system may determine a series of speeds and directional headings to affect movement of heavy machine 101 along a path that substantially avoids perceived obstacles while generally advancing heavy machine 101 along a path leading to an ultimate destination. The destination may be set according to inputs from workflow adjuster 102. The navigation system may update the driving path dynamically while heavy machine 101 is in operation. The navigation system can incorporate data from a GPS system and one or more maps so as to determine the driving path for heavy machine 101.

In one embodiment, controller interface module 221 is configured to communicate with workflow adjuster 102, and receive control commands from workflow adjuster 102. When workflow adjuster 102 issues commands to heavy machine 101, the commands are forwarded to control module 219. Control module 219 may generate control signals to operate heavy machine 101 in accordance with the commands received from workflow adjuster 102.

A discussion regarding the software components used by workflow adjuster 102 for dynamically adjusting workflows to assist heavy machines 101 involved in accidental scenarios ensuring that any detected or predicted accidental scenario is effectively addressed while maintaining operational efficiency is provided below in connection with FIG. 3.

FIG. 3 is a diagram of the software components used by workflow adjuster 102 for dynamically adjusting workflows to assist heavy machines 101 involved in accidental scenarios ensuring that any detected or predicted accidental scenario is effectively addressed while maintaining operational efficiency in accordance with an embodiment of the present disclosure.

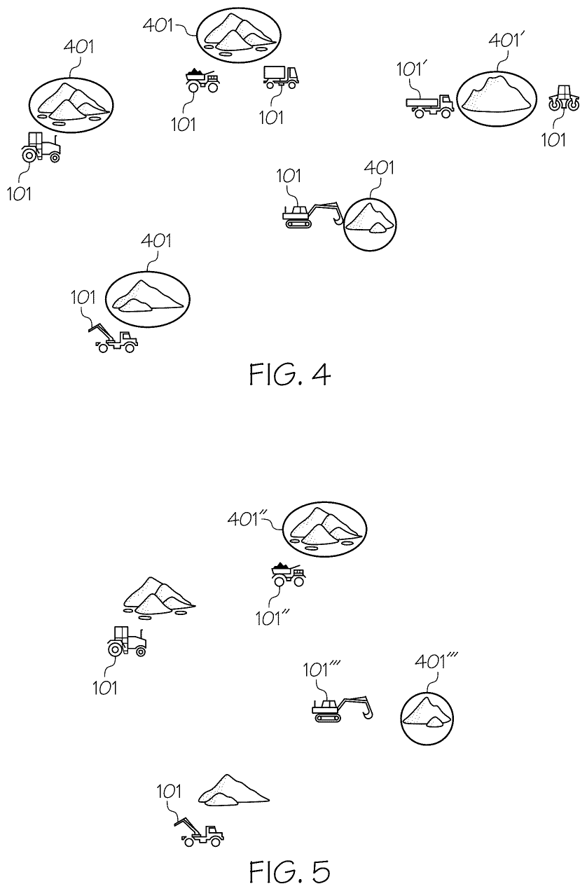

Referring to FIG. 3, in conjunction with FIGS. 1-2, workflow adjuster 102 includes machine learning engine 301, which builds and trains an artificial intelligence model (“first artificial intelligence model”) to make decisions or predictions, such as detecting or predicting an accidental scenario where heavy machine 101 is performing an activity in an activity area as illustrated in FIG. 4. An accidental scenario, as used herein, refers to situations that may be the cause of an accident occurring. For example, structural imbalance during lifting, equipment malfunction, operator error, crushing hazards, falling objects, fire or explosions, chemical exposure, electrical hazards, overloading, collisions, inadequate maintenance, and adverse weather conditions are examples of accidental scenarios involving situations that may lead to accidents within the heavy machine industry. An activity area, as used herein, refers to a particular part of a place or land where heavy machine 101 is performing an activity, such as drilling, lifting, loading, pressing, etc.

Referring to FIG. 4, FIG. 4 illustrates activity areas 401 involving heavy machines 101 performing various activities in accordance with an embodiment of the present disclosure.

As shown in FIG. 4, activity areas 401 include various heavy machines 101 performing various activities, such as digging, scooping, etc.

Returning to FIG. 3, in conjunction with FIGS. 1-2 and 4, in one embodiment, the first artificial intelligence model is trained to detect or predict accidental scenarios based on a sample data set that includes the data associated with activity areas 401 where heavy machines 101 are performing various activities, data pertaining to the capabilities of heavy machines 101, and data pertaining to accidental scenarios involving heavy machines 101 in activity areas 401. Such data may be obtained from an expert and/or from sensors, cameras, etc., such as sensors 104, cameras 105, etc.

In one embodiment, data pertaining to the capabilities of heavy machines 101 may be obtained from digital twin simulations of heavy machines 101 thereby identifying current capabilities of such heavy machines 101 and what types of activities can be performed.

In one embodiment, data pertaining to accidental scenarios involving heavy machines 101 in activity areas 401 includes various types of accidental scenarios (e.g., overloading, chemical exposure) assigned various priorities. Furthermore, such data pertaining to accidental scenarios involving heavy machines 101 in activity areas 401 includes patterns associated with normal or abnormal (accidental) scenarios, such as deviations from expected vibration levels which indicate structural instability or sinking ground, deviations from expected emissions of gases, deviations from expected internal temperatures of heavy machines 101 performing various activities, deviations from expected structural shifts, deviations from normal activity in the activity area's environment, deviations from expected temperatures, humidity and weather conditions contributing to structural instability or ground sinking, etc. In one embodiment, deviations from such expected patterns results in detecting or predicting an accidental scenario.

In one embodiment, the data pertaining to accidental scenarios involving heavy machines 101 in activity areas 401 includes historical data providing a comprehensive list of potential accidental scenarios based on such historical data (e.g., combination of readings, such as temperature, vibration, axial movements, transverse movements, etc.) that could occur during the operation of heavy machine 101, such as equipment malfunction, structural stress, or environmental changes.

In one embodiment, such a sample data set includes rules and thresholds for sensor and image analysis metrics. Sensor metrics, as used herein, refer to the values (e.g., humidity, temperature, vibration level) obtain from sensors 104 in real-time. Image analysis metrics, as used herein, refer to the detected temporal or spatial events from the images or videos captured from cameras 105 in real-time based on video content analysis of the captured images or videos, such as via video analytics software (e.g., IBM Watson® AI, Eagle Eye® VMS, Bosch® Video Analytics, etc.). For example, such temporal or spatial events may correspond to conditions leading to equipment or structural failure. Thresholds may be established for such metrics and crossing such thresholds may indicate an accidental scenario that is detected or predicted. In one embodiment, such thresholds are established by an expert.

Furthermore, in one embodiment, such a sample data set includes trends, recurring patterns, or precursor signals that occurred when accidental scenarios were detected or predicted.

In one embodiment, the sample data set discussed above may be stored in a data structure (e.g., table) residing within the storage device of workflow adjuster 102. In one embodiment, such a sample data set is populated by an expert.

Furthermore, in one embodiment, the sample data set discussed above is referred to herein as the “training data,” which is used by a machine learning algorithm to make predictions or decisions, such as detecting or predicting an accidental scenario involving heavy machine 101 performing an activity in an activity area as discussed above. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the first artificial intelligence model to make decisions or predictions as to the detection or prediction of accidental scenarios, such a trained artificial intelligence model is utilized to make such decisions or predictions based on analyzing monitored real-time data.

In one embodiment, workflow adjuster 102 further includes monitoring engine 302 configured to monitor real-time data associated with an activity area where heavy machine 101 is performing an activity, such as drilling, lifting, loading, pressing, etc.

In one embodiment, monitoring engine 302 monitors the real-time data obtained from various sources, such as sensors 104 and cameras 105 of heavy machines 101. In one embodiment, such sensors 104 and cameras 105 may be installed at strategic locations of activity area 401. Monitoring engine 302 may utilize various software tools for performing such monitoring, which can include, but are not limited to, FactoryWiz™, eNET Client, Datanomix®, MachineMetrics®, etc.

Examples of such real-time data include vibration levels, emission levels, internal temperatures of heavy machines 101, structural shifts, outdoor temperature, humidity, current weather conditions, images of activity area's environment, temporal or spatial events from captured images or videos, etc.

Based on such real-time data, the first trained artificial intelligence model determines whether an accidental scenario has been detected or predicted as discussed above.

For example, based on the real-time monitored data indicating that heavy machine 101 is overloading, an accidental scenario may be detected or predicted. Such overloading may be indicated based on the suspension springs of heavy machine 101 being compressed (obtained from the monitored real-time data) greater than a threshold amount (established for such a metric). In another example, based on the real-time monitored data indicating a deviation from an expected vibration level (obtained from the monitored real-time data) being greater than a threshold amount (established for such a metric), an accidental scenario is detected or predicted. In a further example, based on the real-time monitored data indicating a deviation from the expected emission of carbon monoxide (obtained from the monitored real-time data) being greater than a threshold amount (established for such a metric), an accidental scenario is detected or predicted. In another example, based on the real-time monitored data indicating a deviation from the expected internal temperature of heavy machine 101 (obtained from the monitored real-time data) being greater than a threshold amount (established for such a metric), an accidental scenario is detected or predicted. In a further example, based on the real-time monitored data indicating a deviation from a normal weather condition (obtained from the monitored real-time data) being greater than a threshold amount (established for such a metric), an accidental scenario is detected or predicted.

Furthermore, such monitored real-time data may include various data that together may indicate equipment malfunction, structural stress, or environmental changes, such as based on a comprehensive list of potential accidental scenarios based on such data, thereby causing the trained artificial intelligence model to detect or predict an accidental scenario.

An illustration of detecting or predicting an accidental scenario, such as based on a real-time metric crossing a threshold, is illustrated in FIG. 4.

As shown in FIG. 4, an accidental scenario is detected in activity area 401′ involving heavy machine 101′. For example, an accidental scenario may have been detected due to a vibration level exceeding a threshold level indicating structural instability for heavy machine 101′.

Furthermore, in one embodiment, in addition to training an artificial intelligence model to predict an accidental scenario, machine learning engine 301 is further configured to build and train an artificial intelligence model (“second artificial intelligence model”) to make decisions or predictions, such as identifying heavy machine(s) 101 to assist heavy machine 101 engaged in an activity involving a detected or predicted accidental scenario as well as adjusting the workflow of the assisted heavy machine 101 and/or heavy machine(s) 101 performing the assistance. A workflow, as used herein, refers to the series of steps that a heavy machine (e.g., heavy machine 101) performs in order to achieve a task or goal over time.

In one embodiment, such decisions or predictions are based on a sample data set that includes historical data pertaining to heavy machines 101 assisting heavy machines 101 engaged in activities involving a detected or predicted accidental scenario, including the capabilities of heavy machines 101, the proximity of the assisting heavy machines 101 that were selected to assist heavy machine 101 in need of assistance, the availability of the assisting heavy machines 101 to assist heavy machine 101 in need of assistance, the operational status of the assisting heavy machines 101 that were used to assist heavy machine 101 in need of assistance, capability scores (score that indicates the degree that heavy machine 101 has the capability to assist heavy machine 101 in need of assistance, including finishing the task(s) assigned to heavy machine 101 in need of assistance), accidental scenario priorities (accidental scenarios may be prioritized based on their potential impact on safety, operations, and equipment), etc.

In one embodiment, such a sample data set includes the limitations and constraints of heavy machine 101 in need of assistance and the capabilities of heavy machine(s) 101 providing assistance that were used to address such limitations and constraints.

In one embodiment, such a sample data set includes a ranking of the severity of the accidental scenario, which may be based on the potential impact on safety, operational efficiency, and equipment integrity.

In one embodiment, such a sample data set includes the type of support required based on various scenarios, where such support includes additional machinery (e.g., additional heavy machines 101), expert intervention, or procedural adjustments.

In one embodiment, such a sample data set includes various factors to be considered in selecting the appropriate assisting heavy machines 101, including, but not limited to, the proximity, expertise, availability, and compatibility with the required tasks (required tasks to be performed to assist heavy machine 101 in need of assistance).

In one embodiment, such a sample data set includes the required capabilities for addressing the various accidental scenarios and the specifications, features, and functionalities of the assisting heavy machines 101 that were utilized to assist heavy machine 101 in need of assistance due to the detected or predicted accidental scenario.

In one embodiment, such a sample data set includes potential accidental scenarios that occur during operation of heavy machine 101, where such potential accidental scenarios are prioritized based on their potential impact on safety, operations, and equipment.

In one embodiment, such a sample data set includes which ongoing activities being performed by heavy machine 101 (heavy machine 101 providing assistance to heavy machine 101 engaged in an activity involving a detected or predicted accidental scenario) can be paused. In one embodiment, such criteria for determining which ongoing activities can be paused include the level of completion of the activity, the urgency of support, and the compatibility of the paused activity to the activity to be performed by the assisting heavy machine 101.

In one embodiment, such a sample data set includes integration points in the workflow for heavy machine 101 engaged in the activity involving a detected or predicted accidental scenario where the support actions from the assisting heavy machine(s) 101 can be seamlessly incorporated. Such integration points should allow the support actions to be performed without disrupting the overall workflow.

In one embodiment, such a sample data set includes adjusted workflows for heavy machine 101 providing the assistance as well as for heavy machine 101 engaged in the activity involving a detected or predicted accidental scenario. For example, the workflow for heavy machine 101 providing the assistance may be adjusted to include the tasks, tools, expertise, and procedures for addressing various accidental scenarios in order to mitigate the accidental scenario. In another example, the workflow for heavy machine 101 providing the assistance may be adjusted to temporarily pause activity of heavy machine 101 being performed in its activity area and to include tasks to be performed in the activity area involving the detected or predicted accidental scenario. In a further example, the workflow for heavy machine 101 engaged in the activity involving a detected or predicted accidental scenario may be adjusted to accommodate support actions from heavy machine(s) 101 providing the assistance.

In one embodiment, such a sample data set includes the sequence of support tasks to be performed by supporting heavy machine(s) 101 based on the tasks that need to be performed to mitigate the detected or predicted accidental scenario.

In one embodiment, the sample data set discussed above may be stored in a data structure (e.g., table) residing within the storage device of workflow adjuster 102. In one embodiment, such a sample data set is populated by an expert.

Furthermore, in one embodiment, the sample data set discussed above is referred to herein as the “training data,” which is used by a machine learning algorithm to make predictions or decisions, such as identifying heavy machine(s) 101 to assist heavy machine 101 engaged in an activity involving a detected or predicted accidental scenario as well as adjusting the workflow of the assisted heavy machine 101 and/or heavy machine(s) 101 performing the assistance as discussed above. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the second artificial intelligence model to make decisions or predictions as to identifying heavy machine(s) 101 to assist heavy machine 101 engaged in an activity involving a detected or predicted accidental scenario as well as adjusting the workflow of the assisted heavy machine 101 and/or heavy machine(s) 101 performing the assistance as discussed above, the trained second artificial intelligence model makes decisions or predictions as to identifying heavy machine(s) 101 to assist heavy machine 101 engaged in an activity involving a detected or predicted accidental scenario as well as adjusting the workflow of the assisted heavy machine 101 and/or heavy machine(s) 101 performing the assistance based on analyzing knowledge repository 107.

In one embodiment, such analysis of knowledge repository 107 pertains to the limitations and capabilities of heavy machine 101 engaged in an activity involving a detected or predicted accidental scenario as well as the limitations and capabilities of other heavy machines 101 in or nearby activity area 401 of heavy machine 101 engaged in an activity involving a detected or predicted accidental scenario. In one embodiment, such capabilities include the specifications, features, and functionalities of heavy machines 101. In one embodiment, such analysis may include assigning capability scores pertaining to the tasks that need to be performed in order to mitigate the detected or predicted accidental scenario, such as addressing a chemical leak. For example, if the detected or predicted accidental scenario involves a chemical leak and heavy machine 101 engaged in an activity involving a detected or predicted accidental scenario does not possess the capability for handing a chemical leak, then such a capability will need to be possessed by the assisting heavy machine(s) 101. In one embodiment, such capability scores (score that indicates the degree that heavy machine 101 has the capability to assist heavy machine 101 in need of assistance, including finishing the task(s) assigned to heavy machine 101 in need of assistance) is determined based on relevance and effectiveness in mitigating the detected or predicted accidental scenario.

In one embodiment, such analysis of knowledge repository 107 pertains to the availability of heavy machines 101 located in or nearby activity area 401 of heavy machine 101 engaged in an activity involving a detected or predicted accidental scenario. In one embodiment, such availability is determined based on the status of completing the assigned tasks.

In one embodiment, such analysis of knowledge repository 107 pertains to the accidental scenario priority. In one embodiment, knowledge repository 107 includes a data structure (e.g., table) listing priorities associated with various accidental scenarios. In one embodiment, such a data structure is populated by an expert. In one embodiment, such priorities are established based on their potential impact on safety, operations, equipment, etc. In one embodiment, the severity of such accidental scenarios may be ranked, which may be based on the potential impact on safety, operational efficiency, and equipment integrity. Upon the first artificial intelligence model detecting or predicting an accidental scenario as discussed above, such an accidental scenario is utilized by the second artificial intelligence to identify the priority associated with such an accidental scenario by performing a look-up in such a data structure. In one embodiment, the higher the priority assigned to the accidental scenarios, the greater the importance in assigning heavy machine 101 to assist heavy machine 101 engaged in an activity involving a detected or predicted accidental scenario, including more likely to pause an activity that is currently being performed by the assisting heavy machine 101.

In one embodiment, such analysis of knowledge repository 107 includes the proximity of heavy machines 101 with respect to heavy machine 101 engaged in an activity involving a detected or predicted accidental scenario. Such a proximity may be determined based on the current location of heavy machine 101, which may be based on the location information obtained from a geolocation IoT sensor. The closer heavy machine 101 is located to heavy machine 101 engaged in an activity involving a detected or predicted accidental scenario, the greater the likelihood in selecting such a heavy machine 101 to assist heavy machine 101 engaged in an activity involving a detected or predicted accidental scenario.

In one embodiment, such analysis of knowledge repository 107 includes the operational status of heavy machines 101 that could be used to assist heavy machine 101 engaged in an activity involving a detected or predicted accidental scenario. Operational status, as used herein, refers to whether heavy machine 101 is currently performing an operational function (e.g. lifting). Based on operational status, it may be determined whether heavy machine 101 is available to be deployed to assist heavy machine 101 engaged in an activity involving a detected or predicted accidental scenario.

In one embodiment, such analysis of knowledge repository 107 includes limitations and constraints of heavy machine 101 in need of assistance and the capabilities of heavy machine(s) 101 providing assistance that were used to address such limitations and constraints.

In one embodiment, such analysis of knowledge repository 107 includes various factors to be considered in selecting the appropriate assisting heavy machines 101, including, but not limited to, the proximity, expertise, availability, and compatibility with the required tasks (required tasks to be performed to assist heavy machine 101 in need of assistance).

In one embodiment, such analysis of knowledge repository 107 incudes which ongoing activities being performed by heavy machine 101 (heavy machine 101 providing assistance to heavy machine 101 engaged in an activity involving a detected or predicted accidental scenario) can be paused. In one embodiment, such criteria for determining which ongoing activities can be paused include the level of completion of the activity, the urgency of support, and the compatibility of the paused activity to the activity to be performed by the assisting heavy machine 101 to address the accidental scenario.

In one embodiment, such analysis of knowledge repository 107 incudes integration points in the workflow for heavy machine 101 engaged in the activity involving a detected or predicted accidental scenario where the support actions from the assisting heavy machine(s) 101 can be seamlessly incorporated. Such integration points should allow the support actions to be performed without disrupting the overall workflow.

In one embodiment, such analysis of knowledge repository 107 incudes the tasks, tools, expertise, and procedures for addressing the accidental scenario in question in order to mitigate the accidental scenario. Based on such information, the trained second artificial intelligence model adjusts the workflows for heavy machine 101 providing the assistance as well as for heavy machine 101 engaged in the activity involving a detected or predicted accidental scenario. For example, the workflow for heavy machine 101 providing the assistance may be adjusted to include the tasks, tools, expertise, and procedures for addressing the accidental scenario in order to mitigate the accidental scenario. In a further example, the workflow for heavy machine 101 engaged in the activity involving a detected or predicted accidental scenario may be adjusted to accommodate support actions from heavy machine(s) 101 providing the assistance. In another example, the workflow for heavy machine 101 providing the assistance may be adjusted to temporarily pause activity of heavy machine 101 being performed in its activity area and to include tasks to be performed in the activity area involving the detected or predicted accidental scenario as illustrated in FIG. 5.

Referring to FIG. 5, FIG. 5 illustrates pausing activities being performed by the assisting heavy machines 101 in their activity area so that they can be used to perform tasks in the activity area involving the detected or predicted accidental scenario in accordance with an embodiment of the present disclosure.

As shown in FIG. 5, the activities being performed by heavy machines 101″, 101′″ in activity areas 401″, 401′″, respectively, are temporarily paused and released on a temporary basis to assist heavy machine 101′ engaged in the activity involving a detected or predicted accidental scenario.

Returning to FIG. 3, in conjunction with FIGS. 1-2 and 4-5, in one embodiment, based on the analysis of knowledge repository 107 to identify the tasks, tools, expertise, and procedures for addressing the accidental scenario in question in order to mitigate the accidental scenario, a sequence of support tasks is identified by the trained second artificial intelligence model for supporting heavy machine(s) 101 based on the tasks that need to be performed to mitigate the detected or predicted accidental scenario.

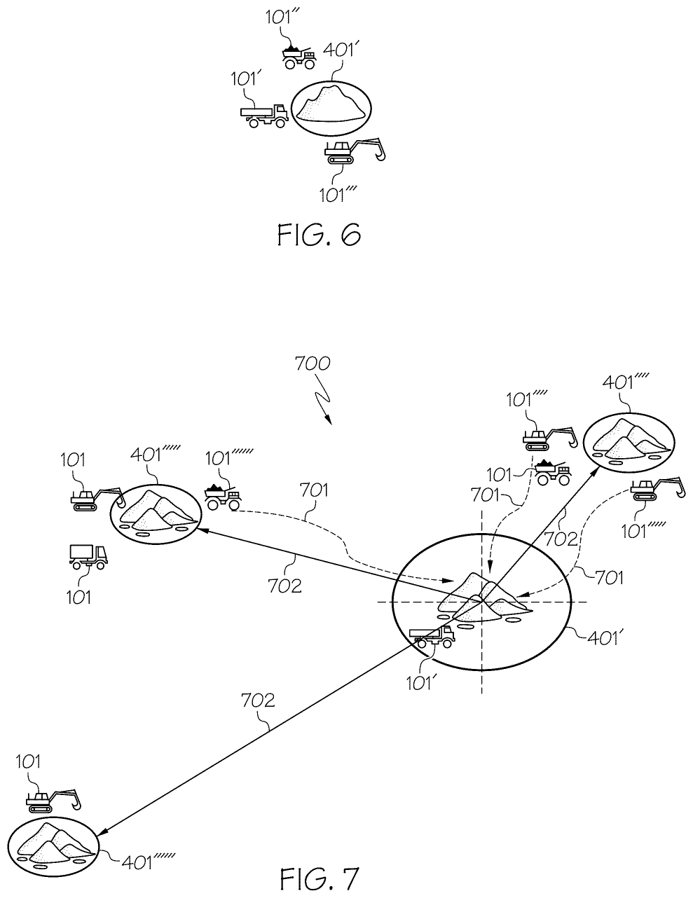

Furthermore, workflow adjuster 102 includes a deployment engine 303 configured to deploy the identified heavy machine(s) to assist heavy machine 101 (heavy machine 101 engaged in the activity involving a detected or predicted accidental scenario) to mitigate the detected or predicted accidental scenario. In one embodiment, such deployment involves performing their adjusted workflows to mitigate the detected or predicted accidental scenario as illustrated in FIG. 6.

FIG. 6 illustrates deploying heavy machines 101 to perform their adjusted workflows to mitigate the detected or predicted accidental scenario in accordance with an embodiment of the present disclosure.

As shown in FIG. 6, heavy machines 101″, 101′″ are deployed to perform their adjusted workflows to mitigate the detected or predicted accidental scenario at activity area 401′. In one embodiment, such heavy machines 101″, 101′″ are deployed to assist heavy machine 101′ engaged in the activity involving the detected or predicted accidental scenario at activity area 401′.

Returning to FIG. 3, in conjunction with FIGS. 1-2 and 4-6, such deployment is performed by deployment engine 303 by issuing commands to the operator of the assisting heavy machines 101, such as via the operator's computing devices (e.g., smartphone). In another embodiment, such deployment is performed by deployment engine 303 by issuing commands to the assisting heavy machine 101, such as those that are autonomous. In such an embodiment, the commands are issued to controller interface module 221, which is forward to control module 219. Control module 219 may generate control signals to operate heavy machine 101 in accordance with the commands received from deployment engine 303.

Upon the detected or predicted accidental scenario being resolved, the deployed heavy machine(s) 101 resume the activities from their paused position in their respective activities areas, which is specified in their adjusted workflow. In one embodiment, such a resolution of the detected or predicted accidental scenario is determined based on the monitored real-time data providing support that the accidental scenario has been resolved. In another embodiment, such a resolution of the detected or predicted accidental scenario is determined based on the completion of the task(s) in the workflow of the assisting heavy machine(s) to address the accidental scenario, where the completion of such task(s) are verified via the values acquired from sensors 104 (e.g., IoT sensors) in comparison to threshold levels.

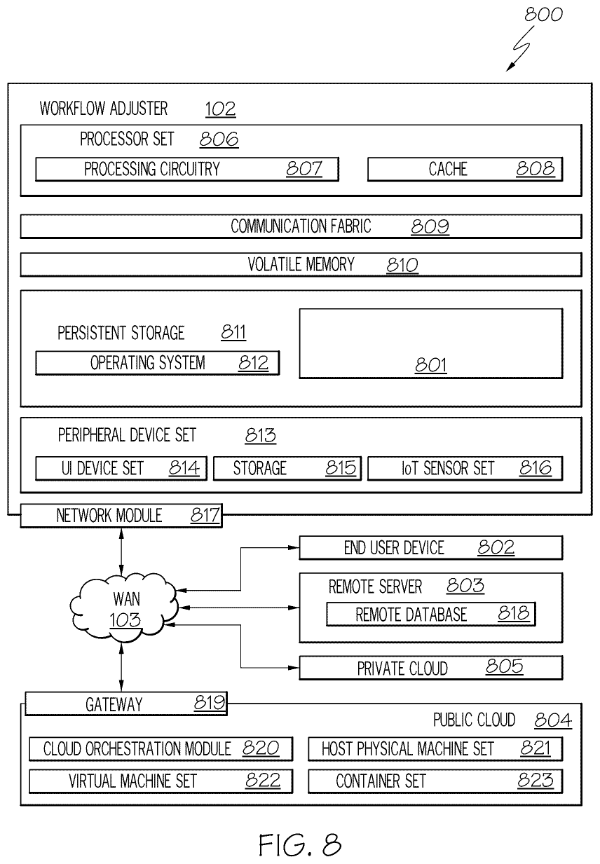

In one embodiment, deployment engine 303 generates a workflow map to illustrate heavy machine(s) 101 being assigned to mitigate the detected or predicted accidental scenario, where such assisting heavy machine(s) 101 provide support actions at suitable integration points in the workflow. These integration points should allow the support actions to be performed without disrupting the overall workflow. In one embodiment, the workflow map provides a visualization of the distances between the activity area where the accidental scenarios was detected or predicted and the locations of heavy machines 101 that can provide the support to mitigate the detected or predicted accidental scenario based on their capacity, distance to the activity area where the accidental scenario was detected or predicted, the performance activity of the assisting heavy machines 101, etc. as shown in FIG. 7.

FIG. 7 illustrates a workflow map 700 illustrating heavy machines 101 being assigned to mitigate the detected or predicted accidental scenario in accordance with an embodiment of the present disclosure.

As shown in FIG. 7, workflow map 700 illustrates various activity areas 401″″, 401″″′, and 401″″″ surrounding activity area 401′ of the detected or predicted accidental scenario. As further illustrated by FIG. 7, heavy machines 101″″, 101″″′, and 101″″″ were selected to provide support to mitigate the detected or predicted accidental scenario at activity area 401′ based on their capacity, distance to the activity area where the accidental scenario was detected or predicted, the performance activity of the assisting heavy machines 101, etc.

In one embodiment, such selected heavy machines (e.g., heavy machines 101″″, 101′″″, and 101″″″) are shown to provide support to mitigate the detected or predicted accidental scenario at activity area 401′ via arrows 701. In one embodiment, the path of such arrows 701 indicate the paths of travel for such heavy machines (e.g., heavy machines 101″″, 101″″′, and 101″″″) to reach activity area 401′.

Furthermore, as illustrated in FIG. 7, distances between the activity area (e.g., activity area 401′) where the accidental scenario was detected or predicted and the activity areas (e.g., activity areas 401″″, 401″″′, and 401″″″) surrounding activity area 401′ of the detected or predicted accidental scenario are marked via arrows 702. In one embodiment, the lengths of such arrows 702 correspond to the distances between such activity areas.

In this manner, workflows may be dynamically adjusted to assist heavy machines involved in accidental scenarios ensuring that any detected or predicted accidental scenario is effectively addressed while maintaining operational efficiency.

A further description of these and other features is provided below in connection with the discussion of the method for dynamically adjusting workflows to assist heavy machines involved in accidental scenarios thereby ensuring that any detected or predicted accidental scenario is effectively addressed while maintaining operational efficiency.

Prior to the discussion of the method for dynamically adjusting workflows to assist heavy machines involved in accidental scenarios thereby ensuring that any detected or predicted accidental scenario is effectively addressed while maintaining operational efficiency, a description of the hardware configuration of workflow adjuster 102 (FIG. 1) is provided below in connection with FIG. 8.

Referring now to FIG. 8, in conjunction with FIG. 1, FIG. 8 illustrates an embodiment of the present disclosure of the hardware configuration of workflow adjuster 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code (stored in block 801) involved in performing the inventive methods, such as dynamically adjusting workflows to assist heavy machines involved in accidental scenarios thereby ensuring that any detected or predicted accidental scenario is effectively addressed while maintaining operational efficiency. In addition to block 801, computing environment 800 includes, for example, workflow adjuster 102, network 103, such as a wide area network (WAN), end user device (EUD) 802, remote server 803, public cloud 804, and private cloud 805. In this embodiment, workflow adjuster 102 includes processor set 806 (including processing circuitry 807 and cache 808), communication fabric 809, volatile memory 810, persistent storage 811 (including operating system 812 and block 801, as identified above), peripheral device set 813 (including user interface (UI) device set 814, storage 815, and Internet of Things (IoT) sensor set 816), and network module 817. Remote server 803 includes remote database 818. Public cloud 804 includes gateway 819, cloud orchestration module 820, host physical machine set 821, virtual machine set 822, and container set 823.

Workflow adjuster 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 818. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically workflow adjuster 102, to keep the presentation as simple as possible. Workflow adjuster 102 may be located in a cloud, even though it is not shown in a cloud in FIG. 8. On the other hand, workflow adjuster 102 is not required to be in a cloud except to any extent as may be affirmatively indicated.

Processor set 806 includes one, or more, computer processors of any type now known or to be developed in the future. Processing circuitry 807 may be distributed over multiple packages, for example, multiple, coordinated integrated circuit chips. Processing circuitry 807 may implement multiple processor threads and/or multiple processor cores. Cache 808 is memory that is located in the processor chip package(s) and is typically used for data or code that should be available for rapid access by the threads or cores running on processor set 806. Cache memories are typically organized into multiple levels depending upon relative proximity to the processing circuitry. Alternatively, some, or all, of the cache for the processor set may be located “off chip. ” In some computing environments, processor set 806 may be designed for working with qubits and performing quantum computing.

Computer readable program instructions are typically loaded onto workflow adjuster 102 to cause a series of operational steps to be performed by processor set 806 of workflow adjuster 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 808 and the other storage media discussed below. The program instructions, and associated data, are accessed by processor set 806 to control and direct performance of the inventive methods. In computing environment 800, at least some of the instructions for performing the inventive methods may be stored in block 801 in persistent storage 811.

Communication fabric 809 is the signal conduction paths that allow the various components of workflow adjuster 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 810 is any type of volatile memory now known or to be developed in the future. Examples include dynamic type random access memory (RAM) or static type RAM. Typically, the volatile memory is characterized by random access, but this is not required unless affirmatively indicated. In workflow adjuster 102, the volatile memory 810 is located in a single package and is internal to workflow adjuster 102, but, alternatively or additionally, the volatile memory may be distributed over multiple packages and/or located externally with respect to workflow adjuster 102.

Persistent Storage 811 is any form of non-volatile storage for computers that is now known or to be developed in the future. The non-volatility of this storage means that the stored data is maintained regardless of whether power is being supplied to workflow adjuster 102 and/or directly to persistent storage 811. Persistent storage 811 may be a read only memory (ROM), but typically at least a portion of the persistent storage allows writing of data, deletion of data and re-writing of data. Some familiar forms of persistent storage include magnetic disks and solid state storage devices. Operating system 812 may take several forms, such as various known proprietary operating systems or open source Portable Operating System Interface type operating systems that employ a kernel. The code included in block 801 typically includes at least some of the computer code involved in performing the inventive methods.

Peripheral device set 813 includes the set of peripheral devices of workflow adjuster 102. Data communication connections between the peripheral devices and the other components of workflow adjuster 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 814 may include components such as a display screen, speaker, microphone, wearable devices (such as goggles and smart watches), keyboard, mouse, printer, touchpad, game controllers, and haptic devices. Storage 815 is external storage, such as an external hard drive, or insertable storage, such as an SD card. Storage 815 may be persistent and/or volatile. In some embodiments, storage 815 may take the form of a quantum computing storage device for storing data in the form of qubits. In embodiments where workflow adjuster 102 is required to have a large amount of storage (for example, where workflow adjuster 102 locally stores and manages a large database) then this storage may be provided by peripheral storage devices designed for storing very large amounts of data, such as a storage area network (SAN) that is shared by multiple, geographically distributed computers. IoT sensor set 816 is made up of sensors that can be used in Internet of Things applications. For example, one sensor may be a thermometer and another sensor may be a motion detector.

Network module 817 is the collection of computer software, hardware, and firmware that allows workflow adjuster 102 to communicate with other computers through WAN 103. Network module 817 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 817 are performed on the same physical hardware device. In other embodiments (for example, embodiments that utilize software-defined networking (SDN)), the control functions and the forwarding functions of network module 817 are performed on physically separate devices, such that the control functions manage several different network hardware devices. Computer readable program instructions for performing the inventive methods can typically be downloaded to workflow adjuster 102 from an external computer or external storage device through a network adapter card or network interface included in network module 817.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 802 is any computer system that is used and controlled by an end user (for example, a customer of an enterprise that operates workflow adjuster 102), and may take any of the forms discussed above in connection with workflow adjuster 102. EUD 802 typically receives helpful and useful data from the operations of workflow adjuster 102. For example, in a hypothetical case where workflow adjuster 102 is designed to provide a recommendation to an end user, this recommendation would typically be communicated from network module 817 of workflow adjuster 102 through WAN 103 to EUD 802. In this way, EUD 802 can display, or otherwise present, the recommendation to an end user. In some embodiments, EUD 802 may be a client device, such as thin client, heavy client, mainframe computer, desktop computer and so on.

Remote server 803 is any computer system that serves at least some data and/or functionality to workflow adjuster 102. Remote server 803 may be controlled and used by the same entity that operates workflow adjuster 102. Remote server 803 represents the machine(s) that collect and store helpful and useful data for use by other computers, such as workflow adjuster 102. For example, in a hypothetical case where workflow adjuster 102 is designed and programmed to provide a recommendation based on historical data, then this historical data may be provided to workflow adjuster 102 from remote database 818 of remote server 803.

Public cloud 804 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 804 is performed by the computer hardware and/or software of cloud orchestration module 820. The computing resources provided by public cloud 804 are typically implemented by virtual computing environments that run on various computers making up the computers of host physical machine set 821, which is the universe of physical computers in and/or available to public cloud 804. The virtual computing environments (VCEs) typically take the form of virtual machines from virtual machine set 822 and/or containers from container set 823. It is understood that these VCEs may be stored as images and may be transferred among and between the various physical machine hosts, either as images or after instantiation of the VCE. Cloud orchestration module 820 manages the transfer and storage of images, deploys new instantiations of VCEs and manages active instantiations of VCE deployments. Gateway 819 is the collection of computer software, hardware, and firmware that allows public cloud 804 to communicate through WAN 103.

Some further explanation of virtualized computing environments (VCEs) will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 805 is similar to public cloud 804, except that the computing resources are only available for use by a single enterprise. While private cloud 805 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 804 and private cloud 805 are both part of a larger hybrid cloud.

Block 801 further includes the software components discussed above in connection with FIGS. 3-7 to dynamically adjust workflows to assist heavy machines involved in accidental scenarios thereby ensuring that any detected or predicted accidental scenario is effectively addressed while maintaining operational efficiency. In one embodiment, such components may be implemented in hardware. The functions discussed above performed by such components are not generic computer functions. As a result, workflow adjuster 102 is a particular machine that is the result of implementing specific, non-generic computer functions.

In one embodiment, the functionality of such software components of workflow adjuster 102, including the functionality for dynamically adjusting workflows to assist heavy machines involved in accidental scenarios thereby ensuring that any detected or predicted accidental scenario is effectively addressed while maintaining operational efficiency, may be embodied in an application specific integrated circuit.

As stated above, accidents within heavy machinery industries encompass a range of hazardous scenarios that can lead to significant consequences for both personnel and equipment. These industries involve complex machinery, intricate processes, and the manipulation of heavy loads, making the potential for accidents a serious concern. Mishaps can arise from various factors, including structural imbalances during material lifting, equipment malfunctions, operator errors, crushing hazards, falling objects, fires, chemical exposure, electrical mishaps, overloading, collisions, inadequate maintenance, and adverse weather conditions. Such accidents can result in injuries, fatalities, property damage, production disruptions, and financial losses. Effective safety protocols, training, regular maintenance, and adherence to proper operational procedures are essential to mitigate these risks and create a safer environment within heavy machinery industries. In heavy machinery industries, various accidental scenarios (situations that may be the cause of an accident occurring) can occur, such as structural imbalance during lifting. For example, while lifting heavy materials, a structural imbalance can cause machinery to tilt, leading to potential instability, material dropping, and machinery damage. In heavy machinery operations, unexpected scenarios or accidents can jeopardize the safety of the operation and the efficiency of the workflow. A workflow refers to the series of steps that a heavy machine performs in order to achieve a task or goal over time. Currently, mechanisms or systems for addressing such accidental scenarios are deficient. For example, context sensing technology may be employed to detect when an operator is texting while operating the heavy machinery. However, such technology is limited to only addressing potential operator errors. Unfortunately, there are currently no mechanisms or systems for effectively addressing the wide range of accidental scenarios, which require immediate detection and dynamic allocation of available resources to support and mitigate the accidental scenarios.

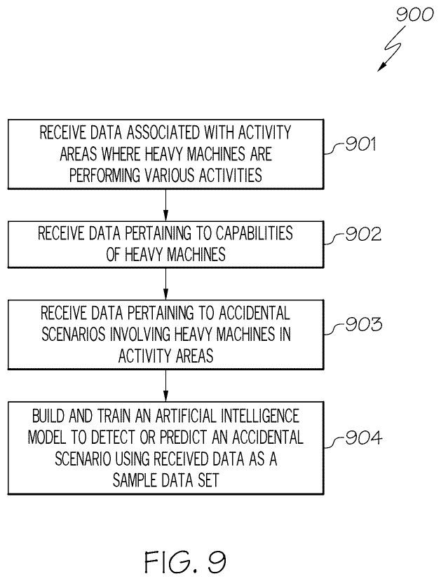

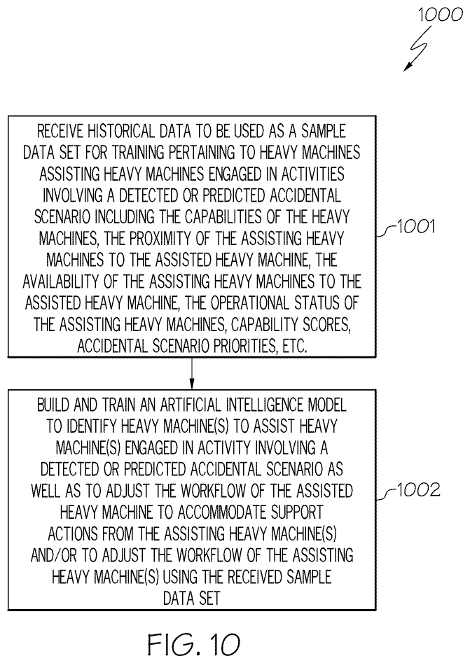

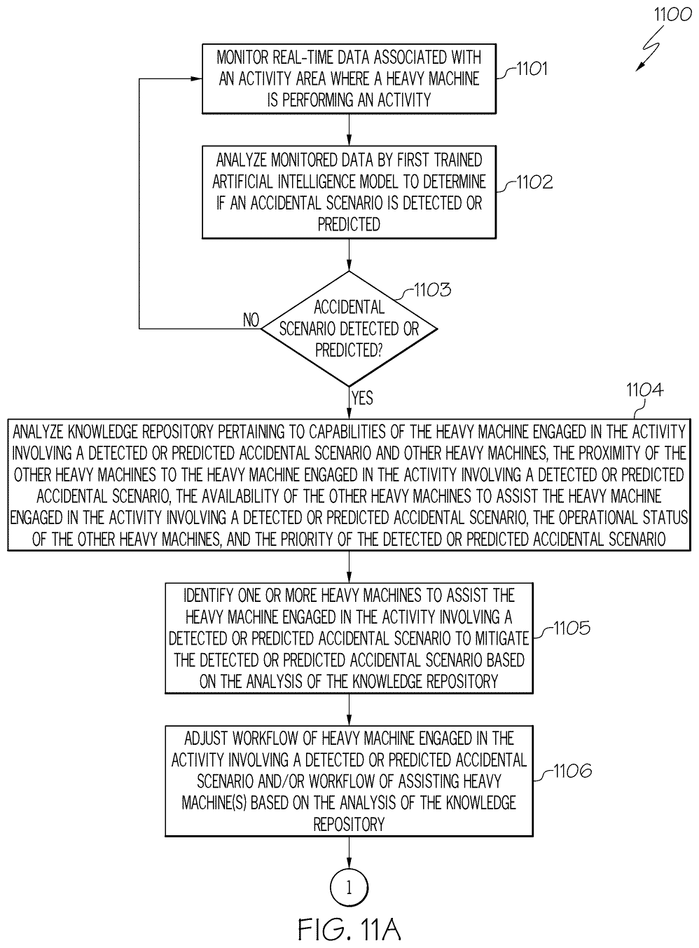

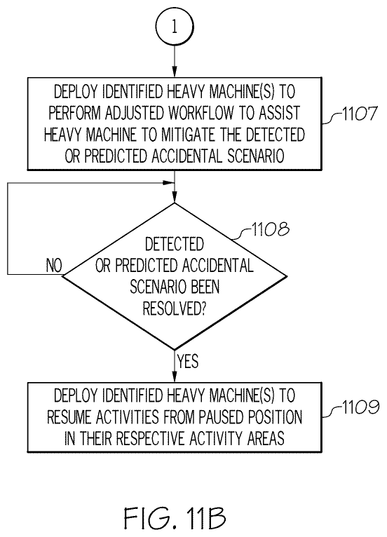

The embodiments of the present disclosure provide a means for dynamically adapting workflows among heavy machines ensuring that any detected or predicted accidental scenario is effectively addressed while maintaining operational efficiency as discussed below in connection with FIGS. 9-10 and 11A-11B. FIG. 9 is a flowchart of a method for building and training an artificial intelligence model for detecting or predicting an accidental scenario. FIG. 10 is a flowchart of a method for building and training an artificial intelligence model for identifying a heavy machine(s) to assist the heavy machine engaged in the activity involving a detected or predicted accidental scenario as well as to dynamically adjust a workflow(s) for the assisting heavy machine(s) and/or the heavy machine engaged in the activity involving the detected or predicted accidental scenario so as to mitigate the detected or predicted accidental scenario. FIGS. 11A-11B are a flowchart of a method for dynamically adjusting the workflow to assist the heavy machines involved in the accidental scenarios.

As stated above, FIG. 9 is a flowchart of a method 900 for building and training an artificial intelligence model for detecting or predicting an accidental scenario in accordance with an embodiment of the present disclosure.

Referring to FIG. 9, in conjunction with FIGS. 1-8, in operation 901, machine learning engine 301 of workflow adjuster 102 receives data associated with activity areas (e.g., activity areas 401) where heavy machines 101 are performing various activities (e.g., drilling, lifting, loading, pressing, etc.).

As stated above, an activity area, as used herein, refers to a particular part of a place or land where heavy machine 101 is performing an activity, such as drilling, lifting, loading, pressing, etc.

In one embodiment, the data associated with activity areas 401 where heavy machines 101 are performing various activities include data obtained from sensors and cameras, such as sensors 104 and cameras 105 which may be attached to heavy machines 101 or located at strategic positions in activity areas 401, pertaining to heavy machines 101 and activity areas 401. Examples of such data include materials lifted by heavy machine 101, such as the weight of such materials, equipment movements to detect equipment malfunctions, operator movements to detect operator errors, data pertaining to monitoring for falling objects, data pertaining to monitoring for electrical issues or fuel leaks which can trigger a fire or explosion, data pertaining to monitoring for chemical leaks or spills which can expose workers to hazardous substances, data pertaining to monitoring for faulty electrical wiring which can lead to electrical hazards, data pertaining to monitoring for exceeding capacity limits of heavy machine 101 leading to possible structural failure, component damage, etc., data pertaining to monitoring for collisions, data pertaining to monitoring for inadequate maintenance, data pertaining to monitoring for adverse weather conditions, etc.

Other examples of such data include location data, such as the location of heavy machine 101, which is obtained in real-time via the use of an IoT-based global position system (GPS) tracking system, temperature and vibration data that can be used to detect the onset of mechanical failure, acceleration data (obtained from accelerometers), orientation and angular velocity data (obtained from gyroscopes), vibration data (obtained from ground movement sensors), images of the environment surrounding heavy machine 101, etc.

In operation 902, machine learning engine 301 of workflow adjuster 102 receives data pertaining to the capabilities of heavy machines 101.

As discussed above, in one embodiment, the data pertaining to the capabilities of heavy machines 101 may be obtained from digital twin simulations of heavy machines 101 thereby identifying current capabilities of such heavy machines 101 and what types of activities can be performed.

In operation 903, machine learning engine 301 of workflow adjuster 102 receives data pertaining to accidental scenarios involving heavy machines 101 in activity areas (e.g., activity areas 401).

As stated above, in one embodiment, the data pertaining to accidental scenarios involving heavy machines 101 in activity areas 401 includes various types of accidental scenarios (e.g., overloading, chemical exposure) assigned various priorities. Furthermore, such data pertaining to accidental scenarios involving heavy machines 101 in activity areas 401 includes patterns associated with normal or abnormal (accidental) scenarios, such as deviations from expected vibration levels which indicate structural instability or sinking ground, deviations from expected emissions of gases, deviations from expected internal temperatures of heavy machines 101 performing various activities, deviations from expected structural shifts, deviations from normal activity in the activity area's environment, deviations from expected temperatures, humidity and weather conditions contributing to structural instability or ground sinking, etc. In one embodiment, deviations from such expected patterns results in detecting or predicting an accidental scenario.

In one embodiment, the data pertaining to accidental scenarios involving heavy machines 101 in activity areas 401 includes historical data providing a comprehensive list of potential accidental scenarios based on such historical data (e.g., combination of readings, such as temperature, vibration, axial movements, transverse movements, etc.) that could occur during the operation of heavy machine 101, such as equipment malfunction, structural stress, or environmental changes.

In operation 904, machine learning engine 301 of workflow adjuster 102 builds and trains an artificial intelligence model (“first artificial intelligence model”) to detect or predict an accidental scenario using the data received in operations 901-903 as a sample data set as well as other types of data discussed further below.

As stated above, machine learning engine 301 builds and trains the first artificial intelligence model to make decisions or predictions, such as detecting or predicting an accidental scenario where heavy machine 101 is performing an activity in an activity area as illustrated in FIG. 4. An accidental scenario, as used herein, refers to situations that may be the cause of an accident occurring. For example, structural imbalance during lifting, equipment malfunction, operator error, crushing hazards, falling objects, fire or explosions, chemical exposure, electrical hazards, overloading, collisions, inadequate maintenance, and adverse weather conditions are examples of accidental scenarios involving situations that may lead to accidents within the heavy machine industry. An activity area, as used herein, refers to a particular part of a place or land where heavy machine 101 is performing an activity, such as drilling, lifting, loading, pressing, etc.

As shown in FIG. 4, activity areas 401 include various heavy machines 101 performing various activities, such as digging, scooping, etc.

In one embodiment, the decisions or predictions are based on a sample data set that includes the data associated with activity areas 401 where heavy machines 101 are performing various activities, data pertaining to the capabilities of heavy machines 101, and data pertaining to accidental scenarios involving heavy machines 101 in activity areas 401. Such data may be obtained from an expert and/or from sensors, cameras, etc., such as sensors 104, cameras 105, etc.

In one embodiment, such a sample data set includes rules and thresholds for sensor and image analysis metrics. Sensor metrics, as used herein, refer to the values (e.g., humidity, temperature, vibration level) obtain from sensors 104 in real-time. Image analysis metrics, as used herein, refer to the detected temporal or spatial events from the images or videos captured from cameras 105 in real-time based on video content analysis of the captured images or videos, such as via video analytics software (e.g., IBM Watson® AI, Eagle Eye® VMS, Bosch® Video Analytics, etc.). For example, such temporal or spatial events may correspond to conditions leading to equipment or structural failure. Thresholds may be established for such metrics and crossing such thresholds may indicate an accidental scenario that is detected or predicted. In one embodiment, such thresholds are established by an expert.

Furthermore, in one embodiment, such a sample data set includes trends, recurring patterns, or precursor signals that occurred when accidental scenarios were detected or predicted.

In one embodiment, the sample data set discussed above may be stored in a data structure (e.g., table) residing within the storage device (storage device 811, 815) of workflow adjuster 102. In one embodiment, such a sample data set is populated by an expert.

Furthermore, in one embodiment, the sample data set discussed above is referred to herein as the “training data,” which is used by a machine learning algorithm to make predictions or decisions, such as detecting or predicting an accidental scenario involving heavy machine 101 performing an activity in an activity area as discussed above. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the first artificial intelligence model to make decisions or predictions as to the detection or prediction of accidental scenarios, such a trained artificial intelligence model is utilized to make such decisions or predictions based on analyzing monitored real-time data as discussed further below in connection with FIGS. 11A-11B.

In addition to training an artificial intelligence model to make decisions or predictions as to the detection or prediction of accidental scenarios, an artificial intelligence model may be trained to identify heavy machines 101 to be deployed to mitigate the detected or predicted accidental scenario as discussed below in connection with FIG. 10.

FIG. 10 is a flowchart of a method 1000 for building and training an artificial intelligence model for identifying a heavy machine(s) to assist the heavy machine engaged in the activity involving a detected or predicted accidental scenario as well as to dynamically adjust a workflow(s) for the assisting heavy machine(s) and/or the heavy machine engaged in the activity involving the detected or predicted accidental scenario so as to mitigate the detected or predicted accidental scenario in accordance with an embodiment of the present disclosure.

Referring to FIG. 10, in conjunction with FIGS. 1-9, in operation 1001, machine learning engine 301 of workflow adjuster 102 receives historical data to be used as a sample data set for training pertaining to heavy machines 101 assisting heavy machines 101 engaged in activities involving a detected or predicted accidental scenario including the capabilities of heavy machines 101, the proximity of the assisting heavy machines 101 to the assisted heavy machines 101, the availability of the assisting heavy machines 101 to the assisted heavy machine 101, the operational status of the assisting heavy machines 101, capability scores, accidental scenario priorities, etc.

In operation 1002, machine learning engine 301 of workflow adjuster 102 builds and trains the second artificial intelligence model to identify heavy machine(s) 101 to assist heavy machine(s) 101 engaged in an activity involving a detected or predicted accidental scenario as well as to adjust the workflow of the assisted heavy machine 101 to accommodate support actions from the assisting heavy machine(s) 101 and/or to adjust the workflow of the assisting heavy machine(s) 101 using the received sample data set. A workflow, as used herein, refers to the series of steps that a heavy machine (e.g., heavy machine 101) performs in order to achieve a task or goal over time.

As discussed above, in one embodiment, such decisions or predictions are based on a sample data set that includes historical data pertaining to heavy machines 101 assisting heavy machines 101 engaged in activities involving a detected or predicted accidental scenario, including the capabilities of heavy machines 101, the proximity of the assisting heavy machines 101 that were selected to assist heavy machine 101 in need of assistance, the availability of the assisting heavy machines 101 to assist heavy machine 101 in need of assistance, the operational status of the assisting heavy machines 101 that were used to assist heavy machine 101 in need of assistance, capability scores (score that indicates the degree that heavy machine 101 has the capability to assist heavy machine 101 in need of assistance, including finishing the task(s) assigned to heavy machine 101 in need of assistance), accidental scenario priorities (accidental scenarios may be prioritized based on their potential impact on safety, operations, and equipment), etc.

In one embodiment, such a sample data set includes the limitations and constraints of heavy machine 101 in need of assistance and the capabilities of heavy machine(s) 101 providing assistance that were used to address such limitations and constraints.

In one embodiment, such a sample data set includes a ranking of the severity of the accidental scenario, which may be based on the potential impact on safety, operational efficiency, and equipment integrity.

In one embodiment, such a sample data set includes the type of support required based on various scenarios, where such support includes additional machinery (e.g., additional heavy machines 101), expert intervention, or procedural adjustments.

In one embodiment, such a sample data set includes various factors to be considered in selecting the appropriate assisting heavy machines 101, including, but not limited to, the proximity, expertise, availability, and compatibility with the required tasks (required tasks to be performed to assist heavy machine 101 in need of assistance).

In one embodiment, such a sample data set includes the required capabilities for addressing the various accidental scenarios and the specifications, features, and functionalities of the assisting heavy machines 101 that were utilized to assist heavy machine 101 in need of assistance due to the detected or predicted accidental scenario.

In one embodiment, such a sample data set includes potential accidental scenarios that occur during operation of heavy machine 101, where such potential accidental scenarios are prioritized based on their potential impact on safety, operations, and equipment.

In one embodiment, such a sample data set includes which ongoing activities being performed by heavy machine 101 (heavy machine 101 providing assistance to heavy machine 101 engaged in an activity involving a detected or predicted accidental scenario) can be paused. In one embodiment, such criteria for determining which ongoing activities can be paused include the level of completion of the activity, the urgency of support, and the compatibility of the paused activity to the activity to be performed by the assisting heavy machine 101.

In one embodiment, such a sample data set includes integration points in the workflow for heavy machine 101 engaged in the activity involving a detected or predicted accidental scenario where the support actions from the assisting heavy machine(s) 101 can be seamlessly incorporated. Such integration points should allow the support actions to be performed without disrupting the overall workflow.

In one embodiment, such a sample data set includes adjusted workflows for heavy machine 101 providing the assistance as well as for heavy machine 101 engaged in the activity involving a detected or predicted accidental scenario. For example, the workflow for heavy machine 101 providing the assistance may be adjusted to include the tasks, tools, expertise, and procedures for addressing the accidental scenario in order to mitigate the accidental scenario. In another example, the workflow for heavy machine 101 providing the assistance may be adjusted to temporarily pause activity of heavy machine 101 being performed in its activity area and to include tasks to be performed in the activity area involving the detected or predicted accidental scenario. In a further example, the workflow for heavy machine 101 engaged in the activity involving a detected or predicted accidental scenario may be adjusted to accommodate support actions from heavy machine(s) 101 providing the assistance.

In one embodiment, such a sample data set includes the sequence of support tasks to be performed by supporting heavy machine(s) 101 based on the tasks that need to be performed to mitigate the detected or predicted accidental scenario.

In one embodiment, the sample data set discussed above may be stored in a data structure (e.g., table) residing within the storage device (e.g., storage device 811, 815) of workflow adjuster 102. In one embodiment, such a sample data set is populated by an expert.

Furthermore, in one embodiment, the sample data set discussed above is referred to herein as the “training data,” which is used by a machine learning algorithm to make predictions or decisions, such as identifying heavy machine(s) 101 to assist heavy machine 101 engaged in an activity involving a detected or predicted accidental scenario as well as adjusting the workflow of the assisted heavy machine 101 and/or heavy machine(s) 101 performing the assistance as discussed above. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the second artificial intelligence model to identify a heavy machine(s) 101 to assist heavy machine 101 engaged in the activity involving a detected or predicted accidental scenario as well as to dynamically adjust a workflow(s) to mitigate the detected or predicted accidental scenario, such a trained artificial intelligence model is utilized to identify a heavy machine(s) 101 to assist heavy machine 101 engaged in the activity involving a detected or predicted accidental scenario as well as to dynamically adjust a workflow(s) to mitigate the detected or predicted accidental scenario based on analyzing knowledge repository 107 as discussed further below in connection with FIGS. 11A-11B.

FIGS. 11A-11B are a flowchart of a method 1100 for dynamically adjusting the workflow to assist the heavy machines involved in the accidental scenarios in accordance with an embodiment of the present disclosure.

Referring to FIG. 11A, in conjunction with FIGS. 1-10, in operation 1101, monitoring engine 302 of workflow adjuster 102 monitors real-time data associated with an activity area (e.g., activity area 401) where heavy machine 101 is performing an activity, such as drilling, lifting, loading, pressing, etc.

As discussed above, in one embodiment, monitoring engine 302 monitors the real-time data obtained from various sources, such as sensors 104 and cameras 105 of heavy machines 101. In one embodiment, such sensors 104 and cameras 105 are installed at strategic locations of the activity area. Monitoring engine 302 may utilize various software tools for performing such monitoring, which can include, but are not limited to, FactoryWiz^{TM}, eNET Client, Datanomix®, MachineMetrics®, etc.

Examples of such real-time data include vibration levels, emission levels, internal temperatures of heavy machines 101, structural shifts, outdoor temperature, humidity, current weather conditions, images of activity area's environment, temporal or spatial events from captured images or videos, etc.

In operation 1102, the trained first artificial intelligence model (trained to detect or predict an accidental scenario) analyzes the monitored data to determine if an accidental scenario is detected or predicted.

For example, based on the real-time monitored data indicating that heavy machine 101 is overloading, an accidental scenario may be detected or predicted. Such overloading may be indicated based on the suspension springs of heavy machine 101 being compressed (obtained from the monitored real-time data) greater than a threshold amount (established for such a metric). In another example, based on the real-time monitored data indicating a deviation from an expected vibration level (obtained from the monitored real-time data) being greater than a threshold amount (established for such a metric), an accidental scenario is detected or predicted. In a further example, based on the real-time monitored data indicating a deviation from the expected emission of carbon monoxide (obtained from the monitored real-time data) being greater than a threshold amount (established for such a metric), an accidental scenario is detected or predicted. In another example, based on the real-time monitored data indicating a deviation from the expected internal temperature of heavy machine 101 (obtained from the monitored real-time data) being greater than a threshold amount (established for such a metric), an accidental scenario is detected or predicted. In a further example, based on the real-time monitored data indicating a deviation from a normal weather condition (obtained from the monitored real-time data) being greater than a threshold amount (established for such a metric), an accidental scenario is detected or predicted.

Furthermore, such monitored real-time data may include various data that together may indicate equipment malfunction, structural stress, or environmental changes, such as based on a comprehensive list of potential accidental scenarios based on such data, thereby causing the trained artificial intelligence model to detect or predict an accidental scenario.

An illustration of detecting or predicting an accidental scenario, such as based on a real-time metric crossing a threshold, is illustrated in FIG. 4.

As shown in FIG. 4, an accidental scenario is detected in activity area 401′ involving heavy machine 101′. For example, an accidental scenario may have been detected due to a vibration level exceeding a threshold level indicating structural instability for heavy machine 101′.

In operation 1103, the first artificial intelligence model (trained to detect or predict an accidental scenario) determines whether an accidental scenario is detected or predicted (such detecting or predicting is collectively referred to herein as “inferring”).

If the first artificial intelligence model (trained to detect or predict an accidental scenario) does not detect or predict (i.e., infer) an accidental scenario, then monitoring engine 302 continues to monitor real-time data associated with an activity area (e.g., activity area 401) where heavy machine 101 is performing an activity, such as drilling, lifting, loading, pressing, etc., in operation 1101.

If, however, the first artificial intelligence model (trained to detect or predict an accidental scenario) detects or predicts (i.e., infers) an accidental scenario, then, in operation 1104, the second trained artificial intelligence model (trained to identify a heavy machine(s) to assist the heavy machine engaged in the activity involving a detected or predicted accidental scenario as well as to dynamically adjust a workflow(s) to mitigate the detected or predicted accidental scenario) analyzes knowledge repository 107 pertaining to capabilities of heavy machine 101 (heavy machine 101 engaged in the activity involving a detected or predicted accidental scenario) and other heavy machines 101, the proximity of heavy machines 101 to heavy machine 101 engaged in the activity involving a detected or predicted accidental scenario, the availability of the other heavy machines 101 to assist machine 101 engaged in the activity involving a detected or predicted accidental scenario, the operational status of the other heavy machines 101, and the priority of the detected or predicted accidental scenario.

As stated above, in one embodiment, such analysis of knowledge repository 107 pertains to the limitations and capabilities of heavy machine 101 engaged in an activity involving a detected or predicted accidental scenario as well as the limitations and capabilities of other heavy machines 101 in or nearby activity area 401 of heavy machine 101 engaged in an activity involving a detected or predicted accidental scenario. In one embodiment, such capabilities include the specifications, features, and functionalities of heavy machines 101. In one embodiment, such analysis may include assigning capability scores pertaining to the tasks that need to be performed in order to mitigate the detected or predicted accidental scenario, such as addressing a chemical leak. For example, if the detected or predicted accidental scenario involves a chemical leak and heavy machine 101 engaged in an activity involving a detected or predicted accidental scenario does not possess the capability for handing a chemical leak, then such a capability will need to be possessed by the assisting heavy machine(s) 101. In one embodiment, such capability scores (score that indicates the degree that heavy machine 101 has the capability to assist heavy machine 101 in need of assistance, including finishing the task(s) assigned to heavy machine 101 in need of assistance) is determined based on relevance and effectiveness in mitigating the detected or predicted accidental scenario.

In one embodiment, such analysis of knowledge repository 107 pertains to the availability of heavy machines 101 located in or nearby activity area 401 of heavy machine 101 engaged in an activity involving a detected or predicted accidental scenario. In one embodiment, such availability is determined based on the status of completing the assigned tasks.

In one embodiment, such analysis of knowledge repository 107 pertains to the accidental scenario priority. In one embodiment, knowledge repository 107 includes a data structure (e.g., table) listing priorities associated with various accidental scenarios. In one embodiment, such a data structure is populated by an expert. In one embodiment, such priorities are established based on their potential impact on safety, operations, equipment, etc. In one embodiment, the severity of such accidental scenarios may be ranked, which may be based on the potential impact on safety, operational efficiency, and equipment integrity. Upon the first artificial intelligence model detecting or predicting an accidental scenario as discussed above, such an accidental scenario is utilized by the second artificial intelligence to identify the priority associated with such an accidental scenario by performing a look-up in such a data structure. In one embodiment, the higher the priority assigned to the accidental scenarios, the greater the importance in assigning heavy machine 101 to assist heavy machine 101 engaged in an activity involving a detected or predicted accidental scenario, including more likely to pause an activity that is currently being performed by the assisting heavy machine 101.

In one embodiment, such analysis of knowledge repository 107 includes the proximity of heavy machines 101 with respect to heavy machine 101 engaged in an activity involving a detected or predicted accidental scenario. Such a proximity may be determined based on the current location of heavy machine 101, which may be based on the location information obtained from a geolocation IoT sensor. The closer heavy machine 101 is located to heavy machine 101 engaged in an activity involving a detected or predicted accidental scenario, the greater the likelihood in selecting such a heavy machine 101 to assist heavy machine 101 engaged in an activity involving a detected or predicted accidental scenario.

In one embodiment, such analysis of knowledge repository 107 includes the operational status of heavy machines 101 that could be used to assist heavy machine 101 engaged in an activity involving a detected or predicted accidental scenario. Operational status, as used herein, refers to whether heavy machine 101 is currently performing an operational function (e.g. lifting). Based on operational status, it may be determined whether heavy machine 101 is available to be deployed to assist heavy machine 101 engaged in an activity involving a detected or predicted accidental scenario.

In one embodiment, such analysis of knowledge repository 107 includes limitations and constraints of heavy machine 101 in need of assistance and the capabilities of heavy machine(s) 101 providing assistance that were used to address such limitations and constraints.

In one embodiment, such analysis of knowledge repository 107 includes various factors to be considered in selecting the appropriate assisting heavy machines 101, including, but not limited to, the proximity, expertise, availability, and compatibility with the required tasks (required tasks to be performed to assist heavy machine 101 in need of assistance).

In one embodiment, such analysis of knowledge repository 107 incudes which ongoing activities being performed by heavy machine 101 (heavy machine 101 providing assistance to heavy machine 101 engaged in an activity involving a detected or predicted accidental scenario) can be paused. In one embodiment, such criteria for determining which ongoing activities can be paused include the level of completion of the activity, the urgency of support, and the compatibility of the paused activity to the activity to be performed by the assisting heavy machine 101 to address the accidental scenario.

In one embodiment, such analysis of knowledge repository 107 incudes integration points in the workflow for heavy machine 101 engaged in the activity involving a detected or predicted accidental scenario where the support actions from the assisting heavy machine(s) 101 can be seamlessly incorporated. Such integration points should allow the support actions to be performed without disrupting the overall workflow.

In operation 1105, the second trained artificial intelligence model identifies heavy machine(s) 101 to assist heavy machine 101 engaged in an activity involving a detected or predicted accidental scenario to mitigate the detected or predicted accidental scenario based on the analysis of knowledge repository 107 as discussed above.

In operation 1106, the second trained artificial intelligence model adjusts the workflow of heavy machine 101 engaged in the activity involving a detected or predicted accidental scenario and/or the workflow of the assisting heavy machine(s) 101 based on the analysis of knowledge repository 107 as discussed above.

Furthermore, as stated above, such analysis of knowledge repository 107 incudes the tasks, tools, expertise, and procedures for addressing the accidental scenario in question in order to mitigate the accidental scenario. Based on such information, the second trained artificial intelligence model adjusts the workflows for heavy machine 101 providing the assistance as well as for heavy machine 101 engaged in the activity involving a detected or predicted accidental scenario. For example, the workflow for heavy machine 101 providing the assistance may be adjusted to include the tasks, tools, expertise, and procedures for addressing the accidental scenario in order to mitigate the accidental scenario. In a further example, the workflow for heavy machine 101 engaged in the activity involving a detected or predicted accidental scenario may be adjusted to accommodate support actions from heavy machine(s) 101 providing the assistance. In another example, the workflow for heavy machine 101 providing the assistance may be adjusted to temporarily pause activity of heavy machine 101 being performed in its activity area and to include tasks to be performed in the activity area involving the detected or predicted accidental scenario as illustrated in FIG. 5.

As shown in FIG. 5, the activities being performed by heavy machines 101″, 101″′ in activity areas 401″, 401″′, respectively, are temporarily paused and released on a temporary basis to assist heavy machine 101′ engaged in the activity involving a detected or predicted accidental scenario.

Furthermore, based on the analysis of knowledge repository 107 to identify the tasks, tools, expertise, and procedures for addressing the accidental scenario in question in order to mitigate the accidental scenario, a sequence of support tasks is identified by the trained second artificial intelligence model for supporting heavy machine(s) 101 based on the tasks that need to be performed to mitigate the detected or predicted accidental scenario.

Referring now to FIG. 11B, in conjunction with FIGS. 1-10, in operation 1107, deployment engine 303 of workflow adjuster 102 deploys the identified heavy machine(s) 101 to assist heavy machine 101 (heavy machine 101 engaged in the activity involving a detected or predicted accidental scenario) to mitigate the detected or predicted accidental scenario. In one embodiment, such deployment involves performing their adjusted workflows to mitigate the detected or predicted accidental scenario as illustrated in FIG. 6.

As shown in FIG. 6, heavy machines 101″, 101′″ are deployed to perform their adjusted workflows to mitigate the detected or predicted accidental scenario at activity area 401′. In one embodiment, such heavy machines 101″, 101″′ are deployed to assist heavy machine 101′ engaged in the activity involving the detected or predicted accidental scenario at activity area 401′.

In one embodiment, such deployment is performed by deployment engine 303 by issuing commands to the operator of the assisting heavy machines 101, such as via the operator's computing devices (e.g., smartphone). In another embodiment, such deployment is performed by deployment engine 303 by issuing commands to the assisting heavy machine 101, such as those that are autonomous. In such an embodiment, the commands are issued to controller interface module 221, which is forward to control module 219. Control module 219 may generate control signals to operate heavy machine 101 in accordance with the commands received from deployment engine 303.

In operation 1108, deployment engine 303 of workflow adjuster determines if the detected or predicted accidental scenario has been resolved.

If the detected or predicted accidental scenario has not been resolved, then deployment engine 303 of workflow adjuster 102 continues to determine if the detected or predicted accidental scenario has been resolved by the identified heavy machine(s) 101 (those heavy machines 101 identified to assist heavy machine 101 engaged in the activity involving the detected or predicted accidental scenario) that were deployed to perform their adjusted workflows to mitigate the detected or predicted accidental scenario in operation 1108.

If, however, the detected or predicted accidental scenario is resolved, then, in operation 1109, deployment engine 303 of workflow adjuster 102 deploys the identified heavy machine(s) 101 (those heavy machines 101 identified to assist heavy machine 101 engaged in the activity involving the detected or predicted accidental scenario) to resume the activities from their paused position in their respective activities areas 401, which is specified in their adjusted workflow. In one embodiment, such a resolution of the detected or predicted accidental scenario is determined based on the monitored real-time data providing support that the accidental scenario has been resolved. In another embodiment, such a resolution of the detected or predicted accidental scenario is determined based on the completion of the task(s) in the workflow of the assisting heavy machine(s) to address the accidental scenario, where the completion of such task(s) are verified via the values acquired from sensors 104 (e.g., IoT sensors) in comparison to threshold levels.

As stated above, in one embodiment, deployment engine 303 generates a workflow map to illustrate heavy machine(s) 101 being assigned to mitigate the detected or predicted accidental scenario, where such assisting heavy machine(s) 101 provide support actions at suitable integration points in the workflow. These integration points should allow the support actions to be performed without disrupting the overall workflow. In one embodiment, the workflow map provides a visualization of the distances between the activity area where the accidental scenarios was detected or predicted and the locations of heavy machines 101 that can provide the support to mitigate the detected or predicted accidental scenario based on their capacity, distance to the activity area where the accidental scenario was detected or predicted, the performance activity of the assisting heavy machines 101, etc. as shown in FIG. 7.

As illustrated in FIG. 7, workflow map 700 illustrates various activity areas 401″″, 401″″′, and 401″″″ surrounding activity area 401′ of the detected or predicted accidental scenario. As further illustrated by FIG. 7, heavy machines 101″″, 101″″′, and 101″″″ were selected to provide support to mitigate the detected or predicted accidental scenario at activity area 401′ based on their capacity, distance to the activity area where the accidental scenario was detected or predicted, the performance activity of the assisting heavy machines 101, etc.

In one embodiment, such selected heavy machines (e.g., heavy machines 101″″, 101″″′, and 101″″″) are shown to provide support to mitigate the detected or predicted accidental scenario at activity area 401′ via arrows 701. In one embodiment, the path of such arrows 701 indicate the paths of travel for such heavy machines (e.g., heavy machines 101″″, 101″″′, and 101″″″) to reach activity area 401′.

Furthermore, as illustrated in FIG. 7, distances between the activity area (e.g., activity area 401′) where the accidental scenario was detected or predicted and the activity areas (e.g., activity areas 401″″, 401″″′, and 401″″″) surrounding activity area 401′ of the detected or predicted accidental scenario are marked via arrows 702. In one embodiment, the lengths of such arrows 702 correspond to the distances between such activity areas.

In this manner, workflows may be dynamically adjusted to assist heavy machines involved in accidental scenarios ensuring that any detected or predicted accidental scenario is effectively addressed while maintaining operational efficiency.

Furthermore, the principles of the present disclosure improve the technology or technical field involving heavy machinery.

As discussed above, accidents within heavy machinery industries encompass a range of hazardous scenarios that can lead to significant consequences for both personnel and equipment. These industries involve complex machinery, intricate processes, and the manipulation of heavy loads, making the potential for accidents a serious concern. Mishaps can arise from various factors, including structural imbalances during material lifting, equipment malfunctions, operator errors, crushing hazards, falling objects, fires, chemical exposure, electrical mishaps, overloading, collisions, inadequate maintenance, and adverse weather conditions. Such accidents can result in injuries, fatalities, property damage, production disruptions, and financial losses. Effective safety protocols, training, regular maintenance, and adherence to proper operational procedures are essential to mitigate these risks and create a safer environment within heavy machinery industries. In heavy machinery industries, various accidental scenarios (situations that may be the cause of an accident occurring) can occur, such as structural imbalance during lifting. For example, while lifting heavy materials, a structural imbalance can cause machinery to tilt, leading to potential instability, material dropping, and machinery damage. In heavy machinery operations, unexpected scenarios or accidents can jeopardize the safety of the operation and the efficiency of the workflow. A workflow refers to the series of steps that a heavy machine performs in order to achieve a task or goal over time. Currently, mechanisms or systems for addressing such accidental scenarios are deficient. For example, context sensing technology may be employed to detect when an operator is texting while operating the heavy machinery. However, such technology is limited to only addressing potential operator errors. Unfortunately, there are currently no mechanisms or systems for effectively addressing the wide range of accidental scenarios, which require immediate detection and dynamic allocation of available resources to support and mitigate the accidental scenarios.

Embodiments of the present disclosure improve such technology by monitoring real-time data associated with an activity area where a heavy machine is performing an activity, such as drilling, lifting, loading, pressing, etc. Examples of such real-time data include vibration levels, emission levels, internal temperatures of heavy machines, structural shifts, outdoor temperature, humidity, current weather conditions, images of an activity area's environment, temporal or spatial events from captured images or videos, etc. The monitored data may then be analyzed by a first trained artificial intelligence model (trained to detect or predict an accidental scenario) to determine if an accidental scenario is detected or predicted. Upon detecting or predicting an accidental scenario by the first trained artificial intelligence model, a knowledge repository including information, such as the capabilities of the heavy machine engaged in an activity involving the detected or predicted accidental scenario as well as other heavy machines, is analyzed. Other information stored in the knowledge repository include the proximity of the heavy machines to the heavy machine engaged in the activity involving a detected or predicted accidental scenario, the availability of the other heavy machines to assist the heavy machine engaged in the activity involving a detected or predicted accidental scenario, the operational status of the other heavy machines, the priority of the detected or predicted accidental scenario, etc. Based on the analysis of the knowledge repository, a second artificial intelligence model ( trained to identify a heavy machine(s) to assist the heavy machine engaged in the activity involving a detected or predicted accidental scenario as well as to dynamically adjust a workflow(s) to mitigate the detected or predicted accidental scenario) identifies a heavy machine to assist the heavy machine (heavy machine engaged in the activity involving a detected or predicted accidental scenario) to mitigate the detected or predicted accidental scenario. Furthermore, the second artificial intelligence model adjusts the workflow for the heavy machine providing the assistance and/or for the heavy machine engaged in the activity involving the detected or predicted accidental scenario. For example, the workflow for the heavy machine providing the assistance may be adjusted to include the tasks, tools, expertise, and procedures for addressing the accidental scenario in order to mitigate the accidental scenario. In a further example, the workflow for the heavy machine engaged in the activity involving the detected or predicted accidental scenario may be adjusted to accommodate the support actions from the heavy machine providing the assistance. In another example, the workflow for the heavy machine providing the assistance may be adjusted to temporarily pause activity of the heavy machine being performed in its activity area and to include tasks to be performed in the activity area involving the detected or predicted accidental scenario. The identified heavy machine may then be deployed to perform the adjusted workflow to mitigate the detected or predicted accidental scenario. In this manner, workflows may be dynamically adjusted to assist heavy machines involved in accidental scenarios ensuring that any detected or predicted accidental scenario is effectively addressed while maintaining operational efficiency. Furthermore, in this manner, there is an improvement in the technical field involving heaving machinery.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for dynamic workflow adjustments to assist heavy machines involved in accidental scenarios, the method comprising:
monitoring real-time data associated with a first activity area where a first heavy machine is performing an activity;
analyzing the real-time data;
inferring an accidental scenario involving the first heavy machine by a first trained artificial intelligence model based on the analysis of the real-time data;
analyzing a knowledge repository pertaining to capabilities of the first heavy machine and one or more other heavy machines;
identifying a second heavy machine of the one or more other heavy machines to assist the first heavy machine to mitigate the inferred accidental scenario by a second trained artificial intelligence model based on the analysis of the knowledge repository; and
deploying the second heavy machine to assist the first heavy machine to mitigate the inferred accidental scenario.

2. The method as recited in claim 1 further comprising:
adjusting a first workflow of the first heavy machine to accommodate support actions from the second heavy machine; and
adjusting a second workflow of the second heavy machine to temporarily pause activity of the second heavy machine being performed in a second activity area and to include tasks to be performed at the first activity area.

3. The method as recited in claim 2 further comprising:
deploying the second heavy machine to perform the adjusted second workflow.

4. The method as recited in claim 1 further comprising:
deploying the second heavy machine to resume activities from a paused position in a second activity area in response to resolving the inferred accidental scenario.

5. The method as recited in claim 1 further comprising:
receiving a first set of data associated with activity areas where heavy machines are performing various activities;
receiving a second set of data pertaining to capabilities of heavy machines;
receiving a third set of data pertaining to accidental scenarios involving heavy machines in activity areas; and
building and training the first artificial intelligence model to infer an accidental scenario using the first, second, and third sets of received data.

6. The method as recited in claim 1 further comprising:
receiving historical data comprising capabilities of heavy machines, proximity of assisting heavy machines to assisted heavy machine, availability of assisting heavy machines to assist heavy machine, operational status of assisting heavy machines, capability scores, and accidental scenario priorities; and
building and training the second artificial intelligence model to identify one or more heavy machines to assist a heavy machine engaged in an activity involving an inferred accidental scenario using the historical data.

7. The method as recited in claim 1 further comprising:
analyzing the knowledge repository pertaining to the capabilities of the first heavy machine and the one or more other heavy machines, proximity of the one or more other heavy machines to the first heavy machine, availability of assisting the first heavy machine by the one or more other heavy machines, operational status of the one or more other heavy machines, and priority of the inferred accidental scenario.

8. The method as recited in claim 1, wherein the first and second heavy machines are autonomous heavy machines.

9. A computer program product for dynamic workflow adjustments to assist heavy machines involved in accidental scenarios, the computer program product comprising:
a set of one or more computer-readable storage media; and
program instructions, collectively stored in the set of one or more computer-readable storage media, for causing a processor set to perform the following computer operations:
monitoring real-time data associated with a first activity area where a first heavy machine is performing an activity;
analyzing the real-time data;
inferring an accidental scenario involving the first heavy machine by a first trained artificial intelligence model based on the analysis of the real-time data;
analyzing a knowledge repository pertaining to capabilities of the first heavy machine and one or more other heavy machines;
identifying a second heavy machine of the one or more other heavy machines to assist the first heavy machine to mitigate the inferred accidental scenario by a second trained artificial intelligence model based on the analysis of the knowledge repository; and
deploying the second heavy machine to assist the first heavy machine to mitigate the inferred accidental scenario.

10. The computer program product as recited in claim 9, wherein the program instructions cause the processer set to perform the following computer operation:
adjusting a first workflow of the first heavy machine to accommodate support actions from the second heavy machine; and
adjusting a second workflow of the second heavy machine to temporarily pause activity of the second heavy machine being performed in a second activity area and to include tasks to be performed at the first activity area.

11. The computer program product as recited in claim 10, wherein the program instructions cause the processer set to perform the following computer operation:
deploying the second heavy machine to perform the adjusted second workflow.

12. The computer program product as recited in claim 9, wherein the program instructions cause the processer set to perform the following computer operation:
deploying the second heavy machine to resume activities from a paused position in a second activity area in response to resolving the inferred accidental scenario.

13. The computer program product as recited in claim 9, wherein the program instructions cause the processer set to perform the following computer operation:
receiving a first set of data associated with activity areas where heavy machines are performing various activities;
receiving a second set of data pertaining to capabilities of heavy machines;
receiving a third set of data pertaining to accidental scenarios involving heavy machines in activity areas; and
building and training the first artificial intelligence model to infer an accidental scenario using the first, second, and third sets of received data.

14. The computer program product as recited in claim 9, wherein the program instructions cause the processer set to perform the following computer operation:
receiving historical data comprising capabilities of heavy machines, proximity of assisting heavy machines to assisted heavy machine, availability of assisting heavy machines to assist heavy machine, operational status of assisting heavy machines, capability scores, and accidental scenario priorities; and
building and training the second artificial intelligence model to identify one or more heavy machines to assist a heavy machine engaged in an activity involving an inferred accidental scenario using the historical data.

15. The computer program product as recited in claim 9, wherein the program instructions cause the processer set to perform the following computer operation:
analyzing the knowledge repository pertaining to the capabilities of the first heavy machine and the one or more other heavy machines, proximity of the one or more other heavy machines to the first heavy machine, availability of assisting the first heavy machine by the one or more other heavy machines, operational status of the one or more other heavy machines, and priority of the inferred accidental scenario.

16. The computer program product as recited in claim 9, wherein the first and second heavy machines are autonomous heavy machines.

17. A system, comprising:
a memory for storing a computer program for dynamic workflow adjustments to assist heavy machines involved in accidental scenarios; and
a processor connected to the memory, wherein the processor is configured to execute program instructions of the computer program comprising:
monitoring real-time data associated with a first activity area where a first heavy machine is performing an activity;
analyzing the real-time data;
inferring an accidental scenario involving the first heavy machine by a first trained artificial intelligence model based on the analysis of the real-time data;
analyzing a knowledge repository pertaining to capabilities of the first heavy machine and one or more other heavy machines;
identifying a second heavy machine of the one or more other heavy machines to assist the first heavy machine to mitigate the inferred accidental scenario by a second trained artificial intelligence model based on the analysis of the knowledge repository; and
deploying the second heavy machine to assist the first heavy machine to mitigate the inferred accidental scenario.

18. The system as recited in claim 17, wherein the program instructions of the computer program further comprise:
adjusting a first workflow of the first heavy machine to accommodate support actions from the second heavy machine; and
adjusting a second workflow of the second heavy machine to temporarily pause activity of the second heavy machine being performed in a second activity area and to include tasks to be performed at the first activity area.

19. The system as recited in claim 18, wherein the program instructions of the computer program further comprise:
deploying the second heavy machine to perform the adjusted second workflow.

20. The system as recited in claim 17, wherein the program instructions of the computer program further comprise:
deploying the second heavy machine to resume activities from a paused position in a second activity area in response to resolving the inferred accidental scenario.
